(19) United States
(12) Patent Application Publication
(10) Pub. No.: US 2026/0030998 A1
(43) Pub. Date: Jan. 29, 2026

(54) INTELLIGENT AND ADAPTIVE FLIGHT TRAINING TOOLS, SYSTEMS, AND CONFIGURATIONS

(71) Applicant: Aircraft Owners and Pilots Association, Frederick, MD (US)

(72) Inventors: Elizabeth Tennyson, New Market, MD (US); Chris Moser, Charles Town, WV (US); Pablo Maurelia, West Chicago, IL (US); Keith West, Middletown, MD (US); Amber Kite, Frederick, MD (US); Rachel Kardos, Sykesville, MD (US); John Hamilton, Frederick, MD (US); Katie Pribyl, Great Falls, MT (US)

(73) Assignee: Aircraft Owners and Pilots Association, Frederick, MD (US)

(21) Appl. No.: 19/346,117

(22) Filed: Sep. 30, 2025

Related U.S. Application Data
(63) Continuation-in-part of application No. 16/538,912, filed on Aug. 13, 2019, now abandoned.
(60) Provisional application No. 62/718,111, filed on Aug. 13, 2018.

(51) Int. Cl. G09B 19/16

(52) U.S. Cl. CPC G09B 19/165

(57) ABSTRACT

A system for flight training includes one or more non-transitory computer-readable memories storing instructions one or more processors executing the instructions to perform operations. The operations include initializing a state and a cognitive load parameter for respective pilot training tasks; determining a subset of the pilot training tasks to include in a first data structure; generating the first data structure including the subset of pilot training tasks; receiving respective scores for the pilot training tasks from a device; updating the respective states of the subset of pilot training tasks based on the received scores; recalibrating the respective cognitive load parameters of the subset of pilot training tasks; updating, based on the recalibrated respective cognitive loads, states of at least one of the subset of pilot training tasks and at least one pilot training task not in the subset; and updating a second data structure based on the updated states.

### CROSS-REFERENCE TO RELATED APPLICATIONS

This application is a continuation-in-part of U.S. application Ser. No. 16/538,912, filed on Aug. 13, 2019, currently pending, which claims the priority benefit of U.S. Provisional Application No. 62/718,111, filed Aug. 13, 2018, which is incorporated herein by reference in its entirety.

### TECHNICAL FIELD

The disclosed embodiments generally relate to a flight training tool. More particularly, embodiments of the present disclosure relate to an adaptive flight training application tool. Embodiments provide an adaptive system that dynamically adjusts to information from multiple sources to enhance digitized flight training output. In this way, pilot training systems are improved.

### BACKGROUND

Becoming a private pilot is a fruitful hobby enjoyed by thousands. However, obtaining the training required to receive a private pilot's license includes many phases and federally-required tasks. In fact, many of the approaches currently in use were developed during and around the time of World War II and were designed to weed out pilot candidates who might take longer or be more difficult to train.

Although approaches to pilot training have changed to some extent since then, the pilot training approaches that were developed during and around that time still underlie today's pilot training programs. The rigidity of those approaches, which were well suited to wartime necessities, are not conducive to busy individuals learning to fly as a hobby. Conventional approaches often require repetitive and rigid training plans, causing many potential pilots to lose interest and quit. Additionally, potential pilots often find the training process to be opaque and difficult to navigate, and become frustrated when the training process unexpectedly costs more or takes longer than originally planned.

Traditional flight training models also adversely affect flight training schools and instructors. Aside from suffering the simple loss of students, schools and instructors are unable to determine patterns in attrition rates or identify solutions. For instance, some students quit their training program following poor experiences with individual instructors, but trends in poor instructor performance may not be discovered because the flight school lacks visibility into training records. The schools must also stock a supply of training resources, increasing costs and logistics. In cases where instructors leave, training schools, future instructors, and students suffer from a lack of instruction continuity.

These aspects have, in part, let to a decline in the number of active general aviation pilots in recent decades, and individuals who begin but do not complete flight training represent a loss to the aviation community. Reversing this trend would be beneficial to general aviation practices. Therefore, in view of the shortcomings and problems with conventional approaches, there is a need for new fight training systems that provide transparency, flexibility, simplicity, and continuity to the flight training process though technological improvements to flight training tools.

### SUMMARY

One aspect of the present disclosure is directed to a system for flight training. The system includes one or more non-transitory computer-readable memories storing instructions; and one or more processors executing the instructions to perform operations. The operations include initializing a state and a cognitive load parameter for respective pilot training tasks, wherein each state comprises at least one of review state, rollover state, skip state, or new state; determining a subset of the pilot training tasks to include in a first data structure; generating the first data structure including the subset of pilot training tasks; receiving respective scores for the pilot training tasks from a device; updating the respective states of the subset of pilot training tasks based on the received scores; recalibrating the respective cognitive load parameters of the subset of pilot training tasks; updating, based on the recalibrated respective cognitive loads, states of at least one of the subset of pilot training tasks and at least one pilot training task not in the subset; and updating a second data structure based on the updated states.

Another aspect of the present disclosure is directed to a computer-implemented flight training method. The method includes executing, via a processor, instructions stored in non-transitory computer-readable medium to perform operations. The operations include initializing a state and a cognitive load parameter for respective pilot training tasks, wherein each state comprises at least one of review state, rollover state, skip state, or new state; determining a subset of the pilot training tasks to include in a first data structure; generating the first data structure including the subset of pilot training tasks; receiving respective scores for the pilot training tasks from a device; updating the respective states of the subset of pilot training tasks based on the received scores; recalibrating the respective cognitive load parameters of the subset of pilot training tasks; updating, based on the recalibrated respective cognitive loads, states of at least one of the subset of pilot training tasks and at least one pilot training task not in the subset; and updating a second data structure based on the updated states.

Other systems, methods, and computer-readable media are also discussed herein.

### BRIEF DESCRIPTION OF THE DRAWINGS

FIG. 1 illustrates a flight training tool system, consistent with the disclosed embodiments.

FIG. 2 is a flowchart a flight training lesson planning and grading process, consistent with the disclosed embodiments.

FIG. 3 is a flowchart of a process to generate a new flight training lesson, consistent with the disclosed embodiments.

FIG. 4 is a flowchart of a process to grade a lesson, consistent with the disclosed embodiments.

FIG. 5 is a flowchart of a lookback process, consistent with the disclosed embodiments.

FIG. 6 is a flowchart of a cognitive load update process, consistent with the disclosed embodiments.

FIG. 7 is an exemplary page hierarchy of flight training tool interfaces, consistent with disclosed embodiments.

FIG. 8 is an exemplary flight training tool student portal dashboard, consistent with the disclosed embodiments.

FIG. 9 is an exemplary flight training tool lesson prep interface, consistent with disclosed embodiments.

FIG. 10 is an exemplary flight training tool lesson history interface, consistent with disclosed embodiments.

FIG. 11 is an exemplary flight training tool student portal lesson detail interface, consistent with the disclosed embodiments.

FIG. 12 is an exemplary flight training tool student portal progress interface, consistent with the disclosed embodiments.

FIG. 13 is an exemplary flight training tool student portal success interface, consistent with the disclosed embodiments.

FIG. 14 is an exemplary flight training tool student resources interface, consistent with the disclosed embodiments.

FIG. 15 is an exemplary flight training tool student profile interface, consistent with the disclosed embodiments.

FIG. 16 is an exemplary flight training tool CFI portal dashboard, consistent with the disclosed embodiments.

FIG. 17 is an exemplary flight training tool CFI portal lesson view, consistent with the disclosed embodiments.

FIG. 18 is an exemplary flight training tool CFI portal lesson grading interface, consistent with the disclosed embodiments.

FIG. 19 is an exemplary flight training tool CFI portal post brief interface, consistent with the disclosed embodiments.

FIG. 20 is an exemplary flight training tool CFI portal next lesson interface, consistent with the disclosed embodiments.

FIG. 21 is an exemplary flight training tool CFI portal alternate lesson interface, consistent with the disclosed embodiments.

FIG. 22 is an exemplary flight training tool CFI portal student profile and progress display interface, consistent with the disclosed embodiments.

FIG. 23 is an exemplary flight training tool CFI portal activity score history interface, consistent with the disclosed embodiments.

FIG. 24 is an exemplary flight training tool CFI portal course requirement tab, consistent with the disclosed embodiments.

FIG. 25 is an exemplary flight training tool CFI portal lesson history tab, consistent with the disclosed embodiments.

FIG. 26 is an exemplary flight training tool CFI portal lesson history detail view, consistent with the disclosed embodiments.

FIG. 27 is an exemplary flight training tool CFI portal currency information tab, consistent with the disclosed embodiments.

FIG. 28 is an exemplary flight training tool CFI portal emergency contact interface, consistent with the disclosed embodiments.

FIG. 29 is an exemplary flight training tool CFI portal student list interface, consistent with the disclosed embodiments.

FIG. 30 is an exemplary flight training tool CFI portal activity index interface, consistent with the disclosed embodiments.

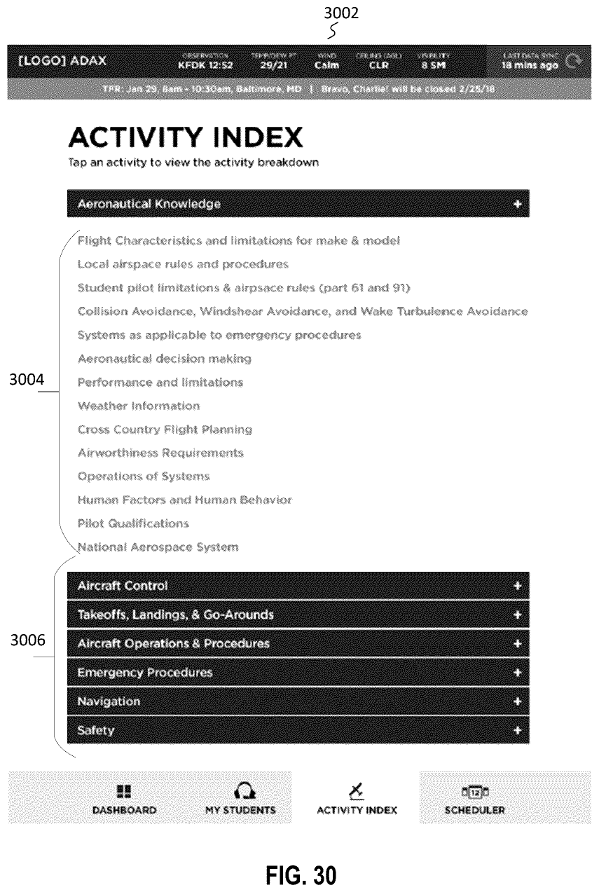

FIG. 31 is an exemplary fight training tool CFI portal activity detail interface, consistent with the disclosed embodiments.

FIG. 32 is an exemplary flight training tool school portal dashboard, consistent with the disclosed embodiments.

FIG. 33 is an exemplary flight training tool school portal student list interface, consistent with the disclosed embodiments.

FIG. 34 is an exemplary flight training tool school portal detailed student profile, consistent with the disclosed embodiments.

FIG. 35 is an exemplary flight training tool school portal CFI list interface, consistent with the disclosed embodiments.

FIG. 36 is an exemplary flight training tool school portal CFI profile interface, consistent with the disclosed embodiments.

FIG. 37 is an exemplary flight training tool school portal preparatory materials interface, consistent with the disclosed embodiments.

FIG. 38 is an exemplary flight training tool school portal activities index interface, consistent with the disclosed embodiments.

FIG. 39 is an exemplary flight training tool school portal activity detail interface, consistent with the disclosed embodiments.

FIG. 40 is an exemplary flight training tool school portal resources interface, consistent with the disclosed embodiments.

FIG. 41 is an exemplary flight training tool school portal school information interface, consistent with the disclosed embodiments.

FIG. 42 is an exemplary flight training tool school portal announcements interface, consistent with the disclosed embodiments.

FIG. 43 is an exemplary flight training tool administrator portal dashboard, consistent with the disclosed embodiments.

FIG. 44 is an exemplary flight training tool administrator portal activity index, consistent with the disclosed embodiments.

FIG. 45 is an exemplary flight training tool administrator portal detailed activity page, consistent with the disclosed embodiments.

FIG. 46 is an exemplary flight training tool administrator portal resources interface, consistent with the disclosed embodiments.

FIG. 47 is an exemplary flight training tool administrator portal course requirements interface, consistent with the disclosed embodiments.

FIG. 48 is an exemplary flight training tool administrator portal school list interface, consistent with the disclosed embodiments.

FIG. 49 is an exemplary flight training tool administrator portal detailed school view, consistent with the disclosed embodiments.

FIG. 50 is an exemplary flight training tool administrator portal user list interface, consistent with the disclosed embodiments.

### DETAILED DESCRIPTION

### Introduction

Embodiments of the present disclosure provide systems and methods for an adaptive flight training tool. For example, in some embodiments, programmatic and pre-determined rules for generating each lesson may ensure that students can continue to make progress in their training even if they are struggling with one or more pilot training activities. In contrast, training tools that lack such adaptive accommodations often result in higher student dropout rates. By minimizing unproductive repetition, students remain engaged in lessons, resulting in a more satisfied and productive student. Flight training tools consistent with disclosed embodiments may introduce new related and/or more advanced activities in ways not supportable using known flight training tools so students can continue to make progress in areas of strength while building on weaknesses in other areas.

Flight training tools disclosed herein react to the performance of an individual student and choose pilot training activities in the most appropriate order. The disclosed tools also provide rules for moving between states which respond to the performance of an individual student while also ensuring the student achieves proficiency in each activity. Such rules may be imbedded in the hardware and software of the new and non-obvious flight training tools described herein and realized by their use in accordance with this description. Descriptions of these rules are included herein in the following specification descriptions and associated figures.

The disclosed flight training tools may ensure that students can continue to make progress in their training even if they are struggling with one or more training activities (whereas known training tools lack such adaptive accommodations, which resulted in higher student dropout rates). The inventors recognize that minimizing unproductive repetition keeps lessons engaging to students, resulting in a more satisfied and productive student.

For example, the flight training tools disclosed herein, by their new and non-obvious design and implementation, help ensure that activities are selected in an appropriate order. For instance, characteristics of the student's home airport are important to ensure that the activities selected make sense in the context of the student's training environment. Multiple factors may be used to determine the student's training environment and students may fall into a category based on flight environment characteristics such as whether they are training at a towered or non-towered airport, whether the airport runway surface is paved, and what type of airspace surrounds the training airport, any or all of which may be determined using information received from an aviation data source and/or a CFI device. Conventional tools have not been able account for such factors when selecting activities, and do not allow for making selections based on information pertaining to such factors. As one example, flight training tools consistent with disclosed embodiments may determine activities (e.g., pilot training tasks) related to operations at towered fields ahead of activities related to operations at non-towered fields, based on an indication of whether a designated training location (e.g., based on an input by a CFI device) is at a towered airport (e.g., where they must speak with air traffic controllers).

In some embodiments, the same lesson design and content may be provided to multiple students, including the first lesson and required stage checks toward earning a pilot certificate, such as those conducted before the first solo flight and before the checkride.

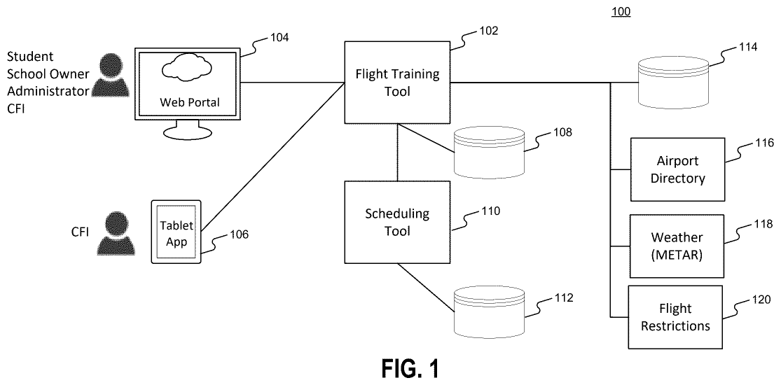

Adaptive flight training tools according to the present disclosure may be implemented as a flight training tool system 100 as illustrated in FIG. 1. Components of system 100 may include one or more computing devices, computing systems, and/or computing device or computing system components configured to execute software instructions stored on one or more non-transitory, computer-readable memory devices to perform one or more operations consistent with the disclosed embodiments. For example, system 100 may include one or more of a server, a computer, an embedded system, or a dedicated hardware device. As used herein, the terms “memory,” “memory device,” “memory medium,” “data storage device,” “data storage medium,” and other terms related to data and/or information storage devices or media refer to non-transitory computer-readable medium.

In certain embodiments, system 100 may be configured as a particular apparatus, and may store, execute, and/or implement software instructions to perform one or more operations consistent with the disclosed embodiments. In some embodiments, flight training tool system 100 consistent with this disclosure may include a cloud-based hosting environment for enabling access to flight training tool system 100 via a communication network, such as the Internet. For example, a cloud-based hosting environment may include a web client in communication with a web application service, which may be in communication with a database (e.g., directly or through a queue and/or other applications, databases, processors, or services). The web client may also be in communication with a file storage device or service via a processor, web-based service, or other system component.

System 100 may be configured to generate and display via display hardware multiple flight training tool graphical user interfaces consistent with the descriptions above and below. Such graphical user interfaces may constitute graphical tools generated through the combination of new and non-obvious combinations of hardware and software, consistent with the descriptions above and below.

In an exemplary embodiment, system 100 may include hardware components and/or software components (e.g., may store computer-readable code or instructions in non-transitory computer-readable medium, such as computer memory) configured to provide, display, store, and transmit a variety of flight training tools. For example, system 100 may include hardware devices configured to store, retrieve, receive, and/or gather information which may be accessed by one or more other components of system 100. For instance, system 100 may include (or be configured to communicate with) hardware devices that include or store aircraft data, flight school data, flight instructor data, flight student data, flight training data (e.g., flight training plan data, flight training statistics data, etc.), weather data, and/or airport data, etc. System 100 may access this information and perform one or more processes to provide and/or configure a flight training tool. For example, system 100 may be configured to provide information to one or more of a web portal or a tablet application on a client device 104.

While the terms “web portal application,” “tablet application,” “mobile application,” mobile device application,” “program application” and “the application,” are discussed herein, it is appreciated that the features of these applications may be combined into a single application (e.g., a flight training tool 102) or distributed between multiple applications (e.g., an application on a client device, 104, 106, and an application on a sever-based device, such as a flight training tool 102).

In one embodiment, system 100 may include a flight training tool 102. The flight training tool may be accessed by a student, school owner, administrator, or certified flight instructor (CFI) using a web portal on a client device 104. Alternatively, the flight training tool may be accessed by a CFI using via a tablet application on a client device 106. As used further below, a “CFI device” may refer to a device to which one or more valid CFI credentials (e.g., CFI credentials associated with and/or identifying a CFI) have been entered. For example, flight training tool 102 (e.g., as implemented through one or more applications) may be configured to provide different functionalities to different accounts or other representations of user permissions. In some embodiments, certain functionalities (e.g., accessible through a portal, consistent with disclosed embodiments) may only be provided to devices associated with (e.g., having in storage, having received as input, having transmitted to flight training tool 102) particular credentials associated with those functionalities, consistent with disclosed embodiments. For example, flight training tool 102 may only enable (e.g., by generating input fields, proceeding with transmitting input data, providing access to a CFI API, etc.) a CFI device to activity data input, or any digital information that could impact generation of digitized lessons. The web portal 104 and the tablet application 106 may access the flight training tool 102 via a network. In some embodiments, the tablet application 106 may download information from the flight training tool 102 for offline access, such as in a cockpit during a flight. In some embodiments, an application may only download information for a limited number of digitized lessons (e.g., a single lesson, the next lesson, a user-selected number of lessons, etc.), to preserve storage space on a device having the application installed. As used herein, “lesson” or “digitized lesson” may refer to a digitized representation of information associated with one or more pilot tasks, such as at least one data structure, for example, an array, table (e.g., hash table), linked list, tree, queue, stack, matrix, an API element, and/or digital file.

It is appreciated that whenever the embodiments herein discuss a “student,” “CFI,” “administrator,” or any other entity, such description may apply equally to an account or device associated with that entity. For example, a “student” may correspond to a device, application, and/or portal to which one or more valid student credentials (e.g., student credentials associated with and/or identifying a student) have been entered. In some embodiments, a portal or API accessible to a student account or device may be different than a portal or API accessible to a CFI student account or device (or that of an administrator, etc.), consistent with disclosed embodiments.

Flight training tool 102 may retrieve aviation data from a number of disparate resources, including database 108, scheduling tool 110, database 114, airport directory 116, weather source 118, and flight restrictions 120. For example, database 108 may contain factors (e.g., variables) used to choose activities for a lesson, such as cognitive load, rank, and the student's home airport characteristics. As used herein, an “activity” may refer to a pilot training task or any observable pilot behavior, which may be represented by at least one digitized data structure, such as an array, hash table, linked list, tree, queue, stack, matrix, an API element, and/or digital file. Scheduling tool 110 may provide flight training tool 102 with information on schedules of students, instructors, and aircraft availability. Scheduling tool 110 may retrieve information from a database 112 in order to generate digitized schedules and provide them to flight training tool 102. Furthermore, database 114 may store information in student records, including personal information and training records, and provide this information to the flight training tool 102. Flight training tool 102 may also access additional resources such as an airport directory 116, a weather resource 118 that provides, for instance, Meteorological Terminal Aviation Routine Weather Reports (METARs), and flight restrictions resource 120 that provides temporary flight restrictions (TFRs). Aviation data, which may include, for example, schedule information, student records, weather information, flight restrictions (e.g., referred to above), may be usable by flight training tool 102 (e.g., as constraints, weighting factors, and/or the like), to initialize, adjust, generate, or influence digitized lessons or pilot training tasks, consistent with disclosed embodiments. Aviation data may also include flight environment characteristics, discussed further below.

For example, flight training tool 102 may determine (e.g., based on a model) that weather information or flight restriction information conflicts with at least one pilot training task or parameter, and may automatically adjust the associated pilot training task (e.g., change a state of one pilot training task to “skip,” change a state of another pilot training task to “new,” and/or adjust a subset of pilot training tasks in a lesson, etc.). Aviation data can change in real time and may impact aircraft and flight planning systems and devices rapidly and suddenly. By using these dynamic and disparate variables, devices and systems such as flight training tool 102 are able to configure and prepare improved flight plans, training outputs, training schedules, and the like, consistent with disclosed embodiments. In some embodiments, flight training tool 102 may access these resources by use of at least one application program interface (API). Additional features of these elements will be described later herein.

In some embodiments, flight training tool 102 may be configured to communicate using different APIs with different resources. For example, flight training tool 102 may be configured to structure communications to a first resource (e.g., scheduling tool 110) to be interpretable by a first API used by that first resource and to structure communications to a second resource (e.g., scheduling tool 110) to be interpretable by a second API used by that second resource. By effectively communicating with multiple resources to obtain digital information useable for the processes described below, flight training tool 102 addresses a problem of handling incompatible and disparate systems, which frequently arises in the realm of computer networks.

Client devices 104, 106 may be one or more computing devices or systems that are configured to execute software instructions for performing one or more operations consistent with the disclosed embodiments. Client devices 104, 106 may be configured to access and provide a user the ability to interact with flight training tool 102. In some embodiments, client devices 104, 106 may be one or more of a mobile device (e.g., a tablet, smartphone, etc.), a laptop, a desktop computer, a server, an embedded system, a dedicated hardware device, etc. Client devices 104, 106 may include one or more computer processors configured to execute software instructions stored in a memory device, such as memory included in client device 104, 106. Client devices 104, 106 may include software that, when executed by a processor, performs network-related communication and content display processes. For instance, client devices 104, 106 may execute browser software that generates and displays interface screens including content on interface hardware (e.g., a display device) included in, or connected to, client devices 104, 106.

In one embodiment, the flight training tool may be or include a combination of web-based applications accessible via a web browser (e.g., web browsing software installed on client device 104, 106) in communication with other components of system 100. In other embodiments, the flight training tool may be or include a mobile device application (or “app”) stored on or operated on client device 104, 106. Furthermore, the app may be operated without an active network connection, such as during a flight. For example, client device 104, 106 may be configured to run a flight training tool app, which may make flight training tools consistent with this disclosure accessible to a user (e.g., receive requests based on user input, display information received from other components of flight training tool system 100, etc.).

Databases 108, 112, and 114 may include one or more memory devices that store information and are accessed and/or managed through a computing device portion of system 100 (e.g., flight training tool 102, scheduling tool 110). By way of example, databases 108, 112, and 114 may include MS SQL, Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In some embodiments, one or more of databases 108, 112, and 114 may be located remotely from the system 100 (e.g., accessible via wired and/or wireless communication systems). Databases 108, 112, and 114 may include computing components (e.g., database management system, database server, etc.) configured to receive and process requests for data stored in memory devices of databases 108, 112, and 114 and to provide data from databases 108, 112, and 114 in response.

Flight training tool 102 may include a computing device (e.g., a processor) and/or a memory device configured to store computer-readable information configured to store and/or display on a hardware device an application or web-browser based graphical tool for interaction with program applications. Program applications may include a series of functional or logical steps provided in computer-readable code that, when executed by a processor, result in the generation or manipulation of graphical user interfaces displayed on display hardware. Such graphical user interfaces include graphical user interfaces consistent with disclosed embodiments.

Scheduling tool 110 may include a computing device (e.g., a processor) and/or a memory device configured to store computer-readable information and/or execute a scheduling program. In some embodiments, scheduling tool 110 may include a third party computing device. A scheduling program may be a series of functional or logical steps provided in computer-readable code that, when executed by a processor, result in the generation or manipulation of information into a schedule format, such as a calendar, timeline, list of information, or other presentation. In some embodiments, flight training tool 102 may be configured to translate a schedule format provided by scheduling tool 110 into a format interpretable and/or displayable by web portal 104 and/or tablet app 106.

Airport directory 116, weather resource 118, and flight restrictions resource 120 may each include a computing device (e.g., a processor) and/or a memory device configured to store computer-readable information and/or display information on a hardware device an application or web-browser based graphical tool. Information systems may include a series of functional or logical steps provided in computer-readable code that, when executed by a processor, result in the generation or manipulation of graphical user interfaces displayed on display hardware. Such graphical user interfaces include graphical user interfaces consistent with disclosed embodiments. Some of these resources may be provided by governmental agencies, such as the Federal Aviation Administration (FAA). Alternatively, these resources may be provided by private organizations, such as the Aircraft Owners and Pilots Association (AOPA). Furthermore, system 100 may include other components that perform or assist in the performance of one or more processes consistent with the disclosed embodiments.

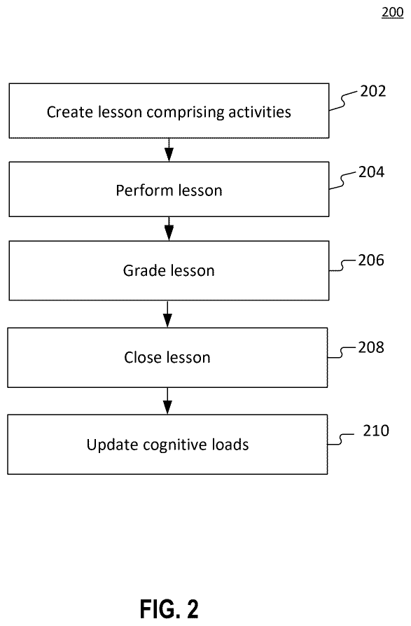

System 100 may implement an adaptive lesson planning process that reacts to the performance of an individual student and chooses activities in the most appropriate order. For example, system 100 may be used to perform functions of process 200 illustrated in FIG. 2, though other systems or devices may perform all or some of the same functions.

At step 202, system 100 generates a digitized lesson for a flight school student. The digitized lesson comprises a number of activity data elements (referred to as “activities” or “lesson activities” herein), which may be structured in a data structure, such as an array, table (e.g., hash table), linked list, tree, queue, stack, matrix, an API element, and/or digital file. Each activity may include a digital state, which may also be referred to as an activity state, which may include as “review,” “rollover,” “skip,” and “new.” The state may be represented by a Boolean value, API variable, API string, field, or any portion of a data structure indicating information about a lesson activity. In some embodiments, new flight students may begin with a standard lesson based on a predetermined flight lesson. In some embodiments, an activity state may be based on (e.g., triggered in response to, dependent upon, interdependent with, or related to) a combination of other parameters, such as activity states, grade inputs, or other information relating to other activities (e.g., in a same lesson or a different lesson), consistent with disclosed embodiments. In some embodiments, flight training tool 102 may limit an activity state to being one of a predefined set.

In some embodiments, generating or adjusting a digitized lesson may include initializing state and/or cognitive load parameters associated with one or more activities (e.g., pilot training tasks), consistent with disclosed embodiments. Additionally, generating or adjusting a digitized lesson may include determining a subset of activities (e.g., pilot training tasks) to include in the digitized lesson (e.g., a data structure), which may be less than a total set of activities known to a system or device (e.g., flight training tool 102).

In some embodiments, multiple digitized lessons and/or activity data elements may be logically connected using digital links, logical operators, nested logical statements, a rule engine (e.g., configured to use JavaScript Object Notation, i.e., JSON, or YAML), a state machine, and/or any digitized structure configured to cause one digitized lesson or activity data element to influence another digitized lesson or activity data element. Additionally, activity data input may also affect the way in which these elements influence one another through their connections (e.g., based on a received score). The one or more logical connections may be used to dynamically change activity states and other digitized lesson-related information, consistent with disclosed embodiments.

After receiving data updates related to a first lesson (e.g., from a device running a web portal 104 or app 106 and/or communicably connected with flight training tool 102), flight training tool 102 may generate and/or adjust the digital contents of one or more lessons (e.g., subsequent lessons in a lesson structure or model) based on certain inputs, such as the instructor's grading of student performance on one or more (e.g., each) components of the lesson. For example, flight training tool 102 may generate or adjust a digitized lesson (e.g., data structure) to have a determined subset of pilot training tasks. This may provide a reliable distributed representation of training-related data.

An activity categorized as review may be an activity in which the student has previously demonstrated proficiency, and which has been included in a lesson to ensure continued proficiency. Some activities may be marked by the flight training tool 102 as not reviewable if they are basic activities that happen on every flight. In some embodiments, training tool 102 may prevent editing or interaction by a device with non-reviewable activities. A predetermined list of activities deemed to be not reviewable once the student has met proficiency standards may be included in the flight training tool 102. Bringing these activities back for review would be unnecessarily redundant. Such activities may include items that must be taught during the early stages of flight training but are simple to perform and are typically part of every lesson and so do not need to be actively reviewed. Examples include taxiing, preflight, and pre-takeoff engine runup.

Further, an activity state of “rollover” may indicate that the corresponding activity may be moved to a subsequent (e.g., the immediately next) lesson, regardless of any grade input. In some embodiments, a rollover state may cause an activity to be automatically moved to a subsequent lesson (e.g., without any user input requesting such movement).

An activity state of “skip” may indicate that the corresponding activity is not included in a lesson to avoid excess repetition, excessive cognitive load, etc. In some embodiments, a skip state may cause an activity to be automatically moved to a subsequent lesson (e.g., without any user input requesting such movement).

An activity state of “new” may indicate that the corresponding activity is an activity the student has not yet performed. In some embodiments, certain combination of activity states for one or more activities may cause an activity state of “new” to be automatically generated and linked to another activity (e.g., without any user input requesting such movement).

Each activity may also include parameters, in addition to the categorization, such as a cognitive load parameter, age parameter, and/or rank parameter. A cognitive load parameter may represent (e.g., be indicative of) the estimated cognitive effort for each activity, and may be represented numerically by a number of “points” (e.g., from 1 to 25, with 25 being greatest). The cognitive load parameter of each activity may be reduced over time as the student's mastery increases. Each activity may be included in an initial cognitive load parameter, which changes over time according to a model, an algorithm, predetermined rules, etc. as calculated, executed, or used by flight training tool 102. For example, a cognitive load parameter of an activity may be increased and/or decreased (e.g., as discussed further herein, for example with respect to step 312) based on one or more cognitive load recalibration factors, which may include, for example, at least one other activity receiving a score below a threshold, at least one other activity receiving a score below a threshold for a predetermined repeated number of instances, a time since at least one score was entered, a time since at least one prior lesson was completed, at least one cognitive load parameter of an activity with a score above a threshold, at least one cognitive load parameter of an activity with a score below a threshold, a number of times at least one activity received a score below a threshold, and/or any tracked information associated with an activity. Any or all of these cognitive load recalibration factors may be used by and/or represented in a function, algorithm, or any model.

Unless otherwise specified, the terms “grade” and “score” are used interchangeably herein, as well as “grading” and “scoring.”

A model may be or include a neural network, encoder, decoder, optimizer, deep learning model, machine learning model, or any artificial intelligence (AI) model. In some embodiments, a model may not be directly accessible to a client device 104 or 106. In some embodiments, flight training tool 102 may store and/or access an initial model that is used as a starting model for multiple users (e.g., students) prior to receiving activity data input for a first digitized lesson, at which point flight training tool 102 may begin to customize the model based on activity data input (e.g., cognitive load recalibration factors). While the term “rule” (“rules” in the plural) is used herein, it is appreciated that this term may refer to a function, conditional logic statement, executable instruction, model, model parameter, model hyperparameter, algorithm, or any computer code.

In some embodiments, a model or rule may be calibrated, adjusted, trained, or retrained, based on information related to a particular entity or event. For example, a model or rule may be adjusted after activity data input is received, such as by using the activity data input to recalibrate cognitive load parameters. Some pilot trainees (or other types of users of techniques described herein) may have different learning abilities and therefore having a flexible and adaptable model or rule may allow for generation of digitized lessons more accurately tailored to the learning abilities of an individual, while not requiring the generation of an entirely new model or rule for each individual. Additionally, a model or rule may be trained or retrained using information related to multiple trainees and/or flights (information that as a whole may be unknown to or inaccessible by a single device, such as a CFI device), to optimize cognitive load parameters, sequencing of activity data element and/or digitized lessons, and the like. Accordingly, a model or rule (e.g., implemented by flight training tool 102) may be optimized leveraging information from multiple activity or training data sources (which may be individually stored with unique credential protection) and further tuned for individual pilots or other users.

Age reflects the amount of time and/or number of since the activity was last performed. Rank reflects the dependency chain of activities and may include a numerical value designated to each activity that shows this dependency. For example, a student pilot must be able to control the airplane in a normal turn before safely flying the traffic pattern at an airport. Therefore, the activity “normal turn” has a lower rank number than the activity “traffic pattern”. At any given point in training, the remaining activities (i.e., those in which the student has not yet been deemed proficient) with the lowest rank numbers are those which most logically follow the activities the student has completed (i.e., been deemed proficient in). Flight training tool 102 may use dependency chains to prevent activities from entering a “new” or “review” state prematurely.

After the lesson is generated, the student and the CFI perform a lesson corresponding to a digitized lesson (e.g., a first lesson or a subsequent lesson), at step 204. In some embodiments, activity data input (e.g., notes and/or scores, which may be linked to, within a data structure, certain activities) may be input at a device, such as web portal 104, tablet app 106, or any tool configured to run or interface with flight training tool 102.

In some embodiments, as discussed further herein, activity data input may be entered while a mobile application (e.g., on client device 104 or 106) receiving the input is offline (e.g., communicably disconnected from flight training tool 102), and may be stored in memory. Then, the activity data input may be automatically synced with flight training tool 102 when network service or Wi-Fi becomes available. This may enable the entry and preservation of activity data input in situations where network connectivity is unavailable, while still allowing for flight training tool 102 to access the activity data input. In some embodiments, the application may prevent a device it is running on from searching for network connectivity for a period of time. For example, the application may prevent searching for network connectivity while a digitized lesson is active (e.g., when a lesson has been initiated based on a received input at a device, when an input indicating the end of a lesson has not yet been received, when a input for at least one activity has not yet been received, and/or when a device sensor indicates that it is airborne or traveling at flight speed, etc.). In this manner, battery life of a device running the application may be preserved, allowing for complete entry of all activity data input without battery life ending prematurely.

At step 206, flight training tool 102 may be used to update a data structure corresponding to a lesson (which may be referred to as “grading the lesson”), which may include updates to one or more states (e.g., based on one or more received scores). The grading of the lesson may be based on activity data input, past activity states, present activity states, and/or other lesson or activity parameters (e.g., cognitive load parameters). For example, activity data input (e.g., notes and scores) may be received at an interface (e.g., web portal 104, tablet app 106), such as in response to one or more inputs by a CFI device, and may be transmitted to flight training tool 102. The activity data input may include each of the activities performed in the lesson, including proficiency information indicating how proficient the student was (e.g., a score) and an indication of whether an activity was linked to any particular state, such as a “skip” state. In some embodiments, grading the lesson may include generating one or more grades associated with the lesson and/or individual activities of the lesson, and/or linking the one or more grades to the lesson, such as by including the one or more grades in a data structure (e.g., an API, array, linked list, table, matrix, JSON object, XML object, GraphQL object, and/or the like) representing the lesson. In some embodiments, step 206 may be initiated based on (e.g., after, in response to, using) an input indicating a completion of the lesson, which in some embodiments, may only be entered by and/or received from a device running a mobile application with validated CFI credentials (e.g., a CFI device).

At step 208, flight training tool 102 closes the lesson. Closing the lesson may include ceasing to display information associated with the lesson, preventing changes to at least a portion of activity data input (e.g., notes, scores, timestamps, etc.), saving a file representing or including the lesson, updating database information, and/or notifying a device (e.g., an application associated with student credentials) of the grading result.

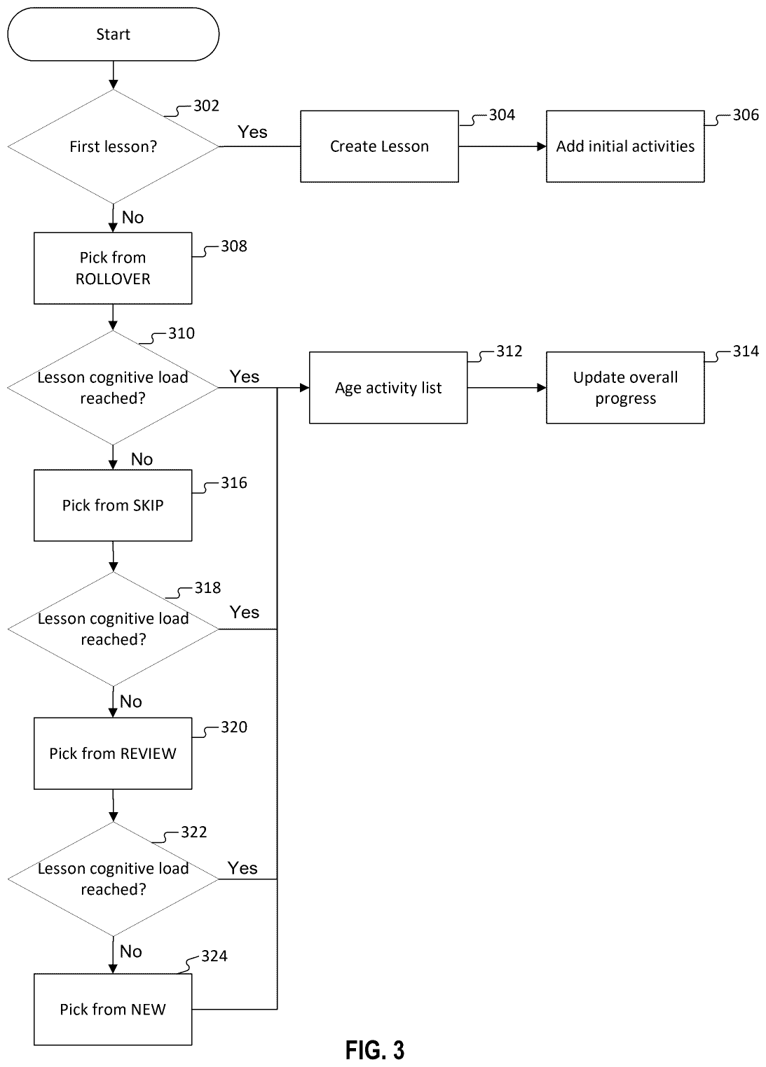

At step 210, flight training tool 102 updates cognitive load parameters associated with the activities according to the grades entered at step 206. Additionally or alternatively, flight training tool 102 may update one or more states of pilot training tasks (e.g., at least one of the subset of pilot training tasks and at least one pilot training task not in the subset). Updating the states of the pilot training tasks may be based on the recalibrated respective cognitive loads, consistent with disclosed embodiments. Subsequently, one or more data structures representing future lessons may be updated (e.g., based on recalibrated cognitive loads and/or updated states), consistent with disclosed embodiments. Further details of these steps will be explained by reference to FIGS. 3-6.

It is appreciated that by updating digital information for future lessons based on a sophisticated state-limited and cognitive load parameter-based configuration, processed using model-based approaches, student (e.g., pilot) learning can be accelerated, but not overaccelerated, in a way not achievable through conventional written gradebooks. Additionally, these approaches (described herein, for example with respect to each and all of FIGS. 2-6) are rapidly adaptable to changing input parameters, such as information from multiple disparate sources, which may use different formats or protocols, while simultaneously leveraging past performance information to more effectively structure and sequence digital information, which may be related to pilot training.

FIG. 3 is a flow chart of an exemplary process for generating a next flight training lesson, consistent with disclosed embodiments. To generate the next lesson, the flight training tool 102 may be configured to select activities to include based on a number of factors, such as each activity's state, cognitive load parameter, and age parameter. Exemplary principles for selecting activities are described below. Each new lesson may be configured to accept a maximum number of activities with rollover, skip, and review activity states to ensure a predetermined threshold space is maintained in a digitized lesson for new activities. In some embodiments, all or some of the process depicted in FIG. 3 may be performed without displaying any information.

At step 302, flight training tool 102 determines if the lesson is a student's first lesson. If step 302 is YES, flight training tool 102 generates a digitized lesson at step 304. The first digitized lesson may include predetermined initial activities added to the lesson at step 306.

However, if step 302 is NO, lessons other than the first lesson are generated by the flight training tool 102 based on one or more activities and corresponding grades, activity data input, activity parameters, and/or activity states. At step 308, flight training tool 102 identifies activities having a rollover state for inclusion in a digitized lesson. In some embodiments, all activities having a rollover state will be included in the lesson being generated so that a lesson cognitive load, calculated as the sum of the cognitive load parameters associated with activities in a single digitized lesson, does not exceed a predetermined cognitive load limit. The cognitive load limit for a lesson may be set at, for instance, 115 points, where no lesson exceeds the 115-point cognitive load limit. In some embodiments, flight training tool 102 may calculate the cognitive load for the lesson as each activity is picked to ensure that the limit is not exceeded for the lesson.

In some embodiments, generating or updating a lesson (e.g., other than a first lesson), such as, e.g., at steps 202, 308, 316, 320, or 324, may be based one or more received scores (or other activity data input). For example, a score may be used to determine whether to update or maintain a state, to determine whether to adjust a cognitive load parameter, and/or to update a model or rule, consistent with disclosed embodiments. In some embodiments, a score may be included in or attached to a digitized lesson (e.g., a digital file and/or API structure, etc.), such as by a CFI device or flight training tool 102. For example, a score may may embedded in a file, such as in the form of metadata. Subsequently, a system (e.g., flight training tool 102) may extract information (e.g., metadata, score information, notes, etc.) from the digitized lesson file and determine which activities, lessons, or parameters to update or adjust based on the extracted score information, consistent with disclosed embodiments.

At step 310, flight training tool 102 determines if the cognitive load limit has been reached. If step 310 is NO, the flight training tool proceeds to step 316 to select activities in the skip state for inclusion in a digitized lesson. An activity may be linked with an activity skip state for many reasons, such as based on weather considerations (e.g., METARs from weather source 118) or lack of time on a previous lesson. In some embodiments, such as where students must complete and achieve proficiency in all activities, flight training tool 102 may require an activity that is skipped in one lesson to be included in at least one future lesson. In some embodiments, most, if not all, skip activities will be added into the digitized lesson being generated without violating the cognitive load limit.

At step 318, flight training tool 102 again determines if the cognitive load limit has been reached. If step 318 is NO, fight training tool 102 proceeds to step 320 to select activities in the review state for inclusion in a digitized lesson. Activities in the review state may be aged based on number of lessons for which they have been selected. The oldest activities (i.e., the activities with the greatest age) in the review list may be picked first. In some embodiments, a student must complete at least four lessons between achieving proficiency in an activity and reviewing that activity, and up to two review activities may be included in a lesson. When an activity from the review list is added to the lesson being generated, its review age may be automatically reset to zero by the flight training tool 102, a factor that may be considered in model updates, cognitive load recalibration, etc.

At step 322, flight training tool 102 again determines if the cognitive load limit has been reached. If step 322 is NO, fight training tool 102 proceeds to step 324 to select activities in the new state. New activities may be picked according to a combination of rank, category, relationship(s) with other activities, and/or characteristics of the activity, consistent with disclosed embodiments. The rules for selecting new activities may be predetermined and included in the logic of flight training tool 102.

If any of steps 310, 318, or 322 are YES, such that the cognitive load has been reached, or once step 324 is completed, flight training tool 102 proceeds to step 312 to age the activity list (e.g., update age parameters of one or more activities). At step 312, activities remaining in the review list after all activities for the lesson have been selected are aged by one lesson. The lesson ages may be stored in database 108, for example.

Furthermore, at step 312, flight training tool 102 may increase the cognitive load parameter of each skip and review activity based on the amount of time elapsed from when a student last performed the activity in a lesson. Cognitive load and/or cognitive load parameters may go down as the student's familiarity with and mastery of the activity increases. In some embodiments, one or more cognitive load parameters may go up as time passes without the student performing the activity. For example, for skip activities, if more than seven days have passed since the activity was included in a lesson, one point may be added to the one or more cognitive load parameters. After 14 days, another point may be added. After 21 days, another point may be added. After one month, the previous lesson may be repeated. After 10 weeks, flight training tool 102 may indicate that an evaluation flight is needed that includes activities in the review state. When a review activity is performed in a lesson, the cognitive load parameter for that activity may be reduced to the same level set for that activity when proficiency was achieved. In some embodiments, if the CFI device deviates from a training plan (e.g., at least one input from a CFI device overrides training plan parameters), flight training tool 102 will refrain from reducing cognitive load points.

At step 314, flight training tool 102 updates the overall progress of the student, based on information associated with activities, which may be associated with respective categories and/or stages. Flight training tool 102 calculates the overall progress, which may be represented by the number of activities for which the student has achieved proficiency (e.g., a threshold score) divided by the number of activities within each category and within each stage. For example, categories may be based on a skill type associated with activities in the category, such as aircraft control, emergency procedures, and takeoffs and landings. A stage may be a segment of the training program, such as pre-solo, solo, cross country, or checkride preparation.

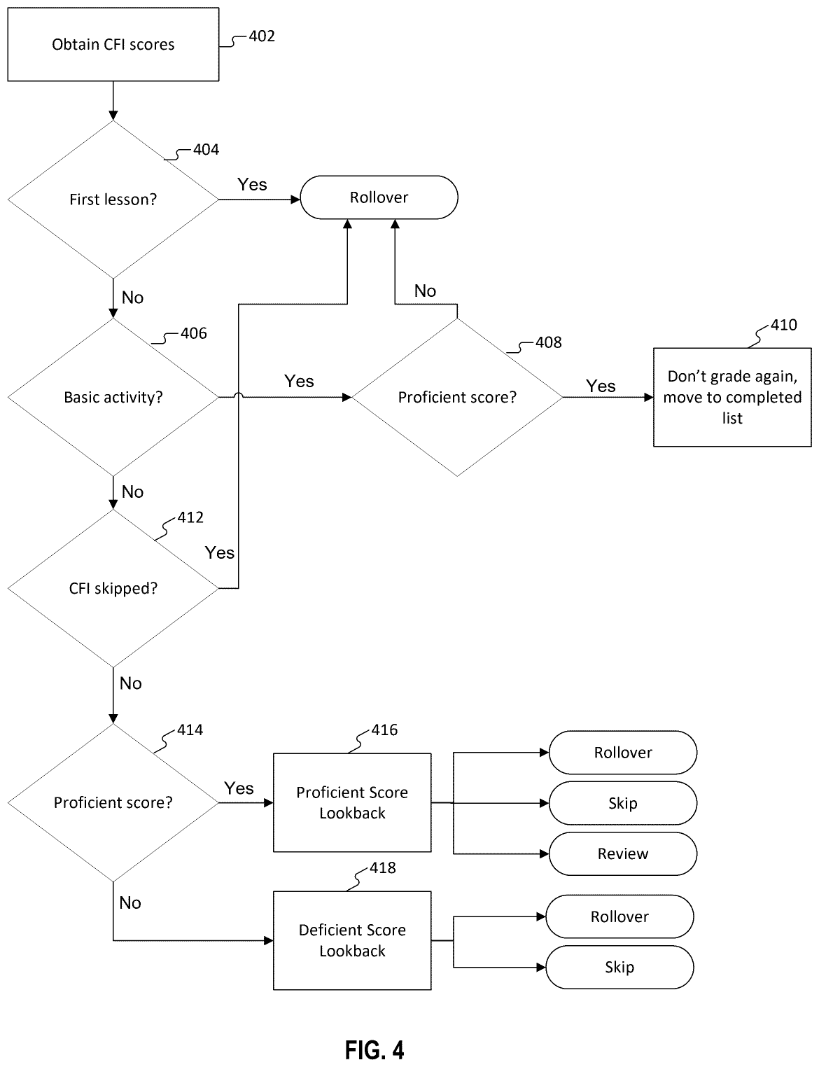

Returning to FIG. 2, step 206 may be better understood by reference to FIG. 4 illustrating a flow chart of grading each activity of a lesson, consistent with disclosed embodiments. The steps illustrated in FIG. 4 may be repeated for each of the activities in a lesson.

At step 402, flight training tool 102 may obtain (e.g., receive or access) scores submitted by the CFI device for activities associated with a digitized lesson (e.g., the activities performed during or associated with the lesson). For example, each activity may be graded by the CFI device using a grading scale of 1 to 5, with 5 being best. The criteria for grading each activity may be based on FAA standards and listed on a grading screen, allowing the CFI device to select a grade. Flight training tool 102 may include an option to enter no score if, for instance, an activity was skipped. For example, flight training tool 102 may permit an entry of no score for an activity only if that activity has been linked to an activity state of “skipped.” This may reduce erroneous or incompatible data entry.

At step 404, flight training tool 102 may determine if the lesson was the first lesson. If step 404 is YES, the activity may be set to the rollover state. If step 404 is NO, flight training tool 102 may proceed to step 406 to determine if the activity is designated as a basic activity. If the activity is designated as a basic activity, step 406 is YES and flight training tool 102 may proceed to step 408 and determines if the score received from the CFI device is a proficient score. If step 408 is YES, the flight training tool 102 may proceed to step 410, records that the activity is complete and does not need to be graded again. Otherwise, if step 408 is NO, flight training tool 408 may set the activity to the rollover state. Unless specified otherwise herein, “proficient score,” “proficient,” and “proficiency” all refer to a score, activity, or lesson (as the case may be) that is associated with one or more scores that are above a threshold “proficiency” value.

However, if step 406 is NO, flight training tool 102 may proceed to step 412 and determines if the CFI device skipped the activity during the lesson, for instance, due to weather (e.g., METARs from weather source 118), time, mechanical issues, or student fatigue. If step 412 is YES, flight training tool 102 may set the activity to the rollover state. If step 412 is NO, flight training tool 102 may proceed to step 414 and determine if the score received from the CFI device was proficient. If step 414 is YES, flight training tool 102 may proceed to step 416 and determine a proficient score lookback (e.g., determination of a proficiency metric above a threshold, such as based on at least one prior score and an amount of time since the score was entered or received). Based on the proficient score lookback, flight training tool 102 sets the activity to one of the rollover, skip, or review states. If step 414 is NO, flight training tool 102 proceeds to step 418, determines a deficient score lookback (e.g., determination of a proficiency metric below a threshold, such as based on at least one prior score and an amount of time since the score was entered or received), and sets the activity to one of the rollover or skip states. As discussed further below, a score not reaching a threshold (e.g., “proficiency threshold”) may be considered a deficient score, and a score that does reach the threshold may be considered a proficient score.

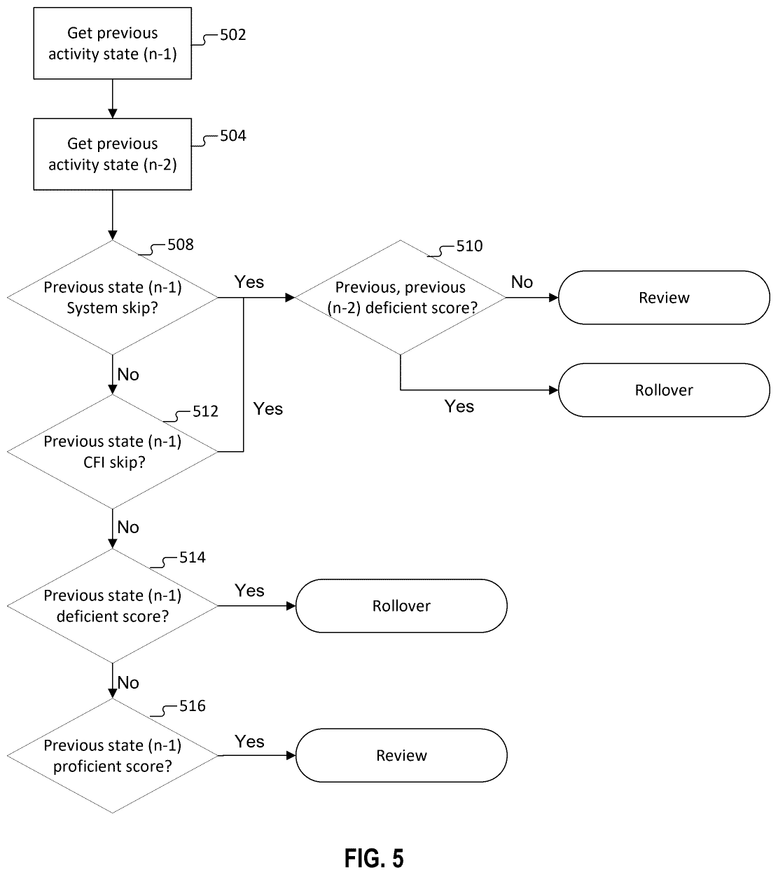

Further explanation of steps 416 and 418 are provided below by reference to FIG. 5. At step 502 flight training tool 102 may obtain the previous state (n−1) associated with the activity. In other words, flight training tool 102 obtains the state associated with the activity prior to the lesson being graded. The state associated with an activity may be, for example, “roll over” (e.g., to indicate an activity that has been moved to the next lesson regardless of grade), “skip” (e.g., to indicate an activity that was skipped over or not set), or “review” (e.g., to indicate an activity in which the student has previously demonstrated proficiency and which has been included to ensure continued proficiency). Similarly, at step 504, flight training tool 102 may obtain the state associated with the activity before the lesson preceding the lesson being graded (n−2).

At step 508, flight training tool 102 may determine if the system skipped an activity previously (i.e., the n−1 state). Similarly, at step 512, flight training tool 102 may determine if the CFI device skipped (e.g., linked with a “skip” activity state) an activity previously (n−1), for instance, due to real-time observations during the lesson such as weather (e.g., METARs from weather source 118) and student fatigue. If either of steps 508 or 512 are YES, flight training tool 102 may proceed to step 510 to determine if there was a previous, previous deficient score (n−2) for the student in an activity. If step 510 is YES, the activity may be set to the rollover state. However, if step 510 is NO, the activity may be set to the review state.

If steps 508 and 512 are NO, flight training tool 102 may proceed to step 514 to determine if the CFI device has previously (n−1) associated the activity with a deficient score. For instance, a deficient score may be a score less than three. If the score is deficient at step 514, flight training tool 102 may set the activity to the rollover state. Alternatively, if step 514 is NO, flight training tool 102 may determine if the previous score (n−1) is proficient at step 516, followed by setting the activity to the review state.

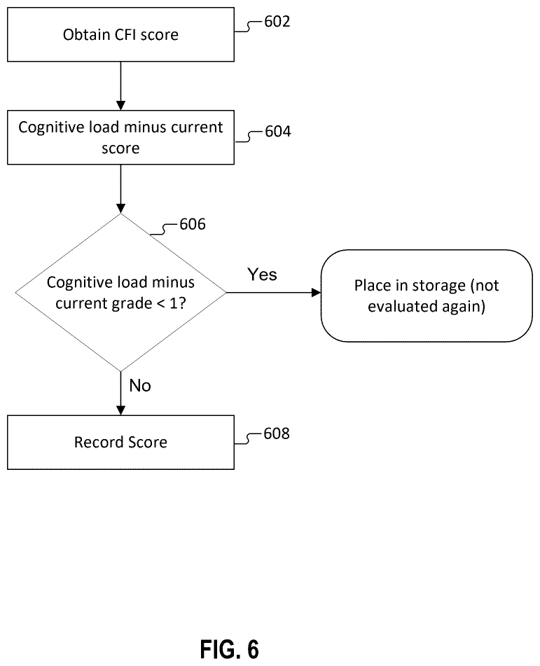

Returning to FIG. 2, step 208 may be better understood by reference to FIG. 6 illustrating a flow chart of updating a cognitive load parameter, consistent with disclosed embodiments. The flight training tool 102 may be configured to update the cognitive load parameter of an activity after the activity has been performed. The initial cognitive load parameter for each activity may be set as a predetermined cognitive load parameter. Flight training tool 102 may obtain (e.g., after completion of a lesson) the CFI score (e.g., score received from a CFI device) at step 602 for an activity. Flight training tool 102 may update a cognitive load parameter based on (e.g., using) the cognitive load parameter itself (e.g., as previously set) and at least one received score. For example, flight training tool 102 may use a cognitive load parameter associated with a pilot training task and a received score associated with the pilot training task as inputs (e.g., variables) to determine (e.g., via a model) an updated cognitive load parameter (e.g., dependent on the previous cognitive load parameter and received score). Flight training tool 102 may perform these operations for one cognitive load parameter or multiple cognitive load parameters. For example, at step 604, flight training tool 102 may subtract the current score for the activity for the current lesson from the previously set cognitive load parameter for that activity. At step 606, flight training tool 102 may determine if the difference calculated at step 604 is less than or equal to one. If the difference is greater than or equal to one, step 606 is NO, and flight training tool 102 may record the score as the new cognitive load parameter associated with the activity at step 608. If the difference is less than one, the score may be electronically stored and the activity may not be evaluated again, or may have a timer incremented (e.g., a timer whose expiration triggers the activity to transition to a different state, optionally based on other factors).

Flight training tool 102 may also provide training information to users by supporting separate views for student devices, CFI devices, school owner devices, and administrator devices. For example, users with appropriate administrative privileges at the administrative level may have a mechanism to upload, update, and remove lesson activities, lesson preparation materials and resources (e.g., which may act as constraints on the models, rules, recalibration, and updating discussed herein). Administrative users may have the ability to add, update, or remove digitized lesson activities. School owners may have the ability to add links to externally hosted and digitized lesson preparation materials and resources (e.g., YouTube videos). Digitized activities, lesson preparation materials, and resources supplied by the system administrator may only be editable through the administrator portal.

Furthermore, flight training tool 102 may indicate student progress by providing pre-configured milestone badges. Flight training tool 102 may be configured to provide a set of standard badges to be included in each student's record and awarded automatically, such as discovery flight, 10 hours, 20 hours, 30 hours, first solo, first night flight, cross-country, cross-country solo, instrument, checkride ready, FAA pilot, etc.

In some embodiments, flight training tool 102 may provide activities tagged with respective states within each lesson. Flight training tool 102 may also provide the ability to specify a home airport identifier. The airport code may be used to obtain information, alerts, warnings, and weather associated with the home airport (e.g., based on METARs from weather source 118). Flight training tool 102 may also provide a resources repository containing general links, documents, and resources.

Fight training tool 102 may also access a list of key training assets along with certain information about those assets, such as profile information of CFIs, including name, address, email, phone number, emergency contact, and certificate number; simulators with make and model; and/or other resources (which may include classroom space, briefing rooms, or other assets the school considers critical to training with location, number of seats, or other identifying information). Assets may be stored within the database 108 to be accessed by flight training tool 102.

Flight training tool 102 may also support off-line data input, for example, using a mobile application. This may allow CFIs to grade the performance of flight students while they are flying and have no internet access in the cockpit. Data that is entered while the application is off-line may be stored in tablet memory, for instance, and then automatically synced with flight training tool 102 when network service or Wi-Fi becomes available.

Flight training tool 102 may also provide basic reports displaying lesson history, activity grading history, progress charts, logbook counts, students, instructors, etc.

In some embodiments, flight training tool 102 may consume weather information for the user's home airport, such as METAR information, flight category, airport name, airport code, observation time, temp, dew point, wind speed and direction, ceiling, and visibility. Additionally, flight training tool 102 may provide alerts and messages such as TFR, notices to airmen (NOTAMS), currency reminders, medical reminders, and custom messages generated by a school owner or system administrator.

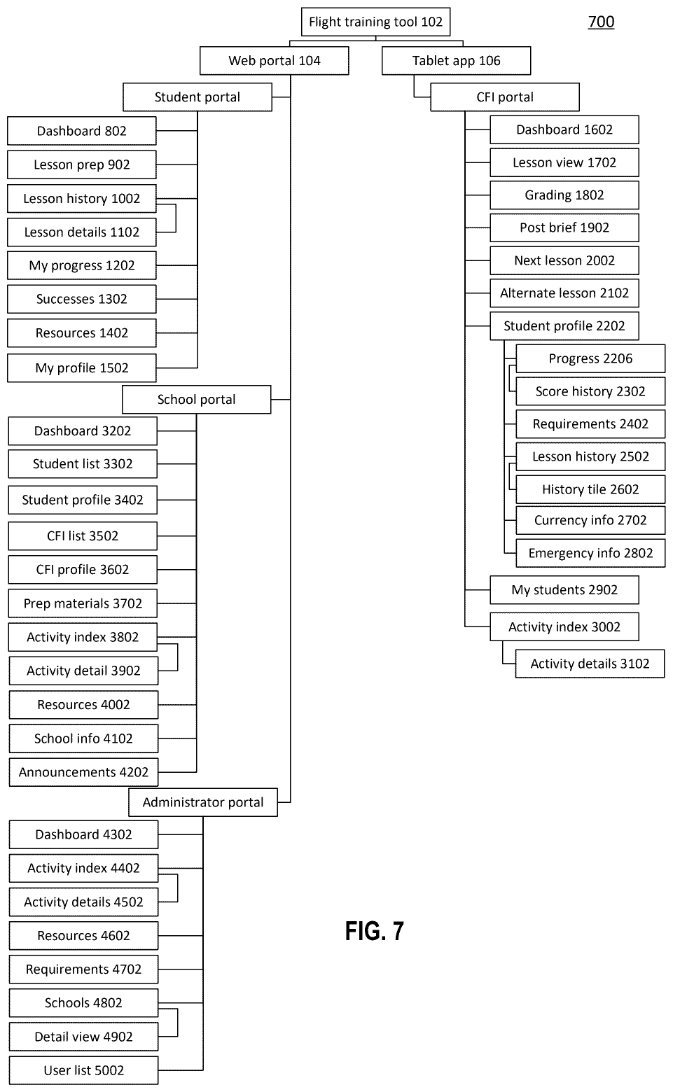

FIG. 7 illustrates an exemplary interface hierarchy 700. As shown in FIG. 7, flight training tool 102 may provide a number of portals, such as a student portal, CFI portal, school portal, and administrator portal. Furthermore, each portal may have a plurality of interfaces. Interfaces may also have pages or tabs. The portals may be accessible by the web portal 104 or tablet app 106. Additional features of these elements will be described subsequently.

### Student Portal

Flight training tool 102 analysis and data may be accessed by a flight training student using, for example, web portal 104. Through web portal 104, flight training tool 102 may provide a student portal to the student. The information displayed to the student using the student portal may include information processed by flight training tool 102 and stored in database 108. The student portal may be the primary access for students to see their progress, lessons, history, and profile. Students may view breakdowns of what they have accomplished by category, goal, and overall activity completion. Lessons may be displayed with each activity graded, the grade received, lesson preparation set for next lesson, and an agenda of what the next lesson's activities will be. Furthermore, flight training tool 102 may provide students the option to review previous lessons and preview the upcoming lesson and associated preparation materials. Additionally, preparation materials may be stored in the resource repository described below.

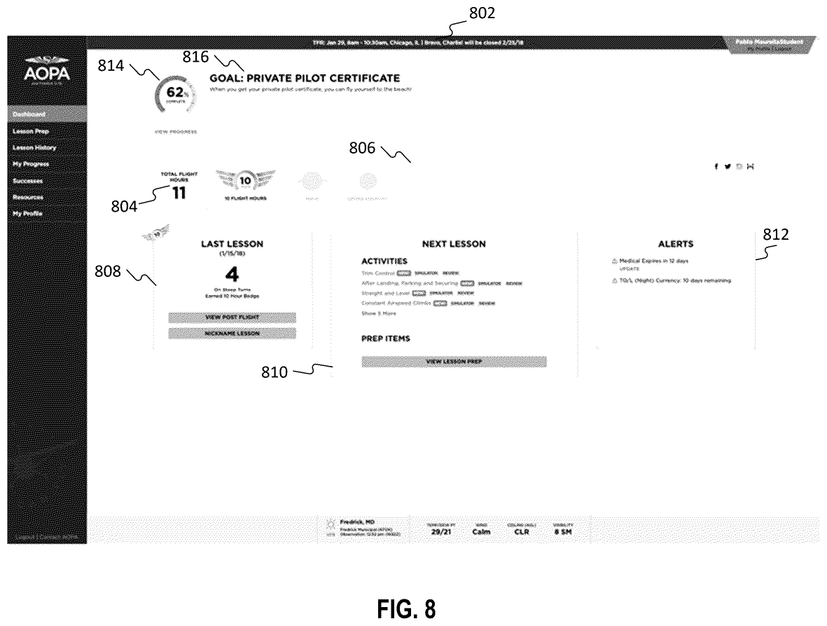

Web portal 104 may be further understood by reference to FIG. 8 showing an illustration of an exemplary flight training tool student portal dashboard 802, consistent with disclosed embodiments. For example, the student portal dashboard interface 802 may display the latest logbook totals 804 including total flight hours, which may be recorded as the Hobbs and Tach time as entered by a CFI after a lesson and calculated by the flight training tool 102. Student portal dashboard 802 may display earned badges 806 reflecting milestones, missions, and achievements during the training process.

Student portal dashboard 802 may also display last lesson information 808, such as date, highlight, bade earned, lesson grade, and post-flight lesson history detail. Similarly, student portal dashboard 802 may display next lesson information 810 and provide access to resources and preparation material, scheduling information, and activities. Student portal dashboard 802 may also display alerts 812 including TFRs, NOTAMS, currency reminders, medical reminders, etc.

Student portal dashboard 802 may also display the student's percent progress 814. For instance, progress may be calculated by the flight training tool 102 by dividing the number of activities required for a student's goal by the number of activities completed. The goal 816 that the student is working towards may also be displayed on student portal dashboard interface 802.

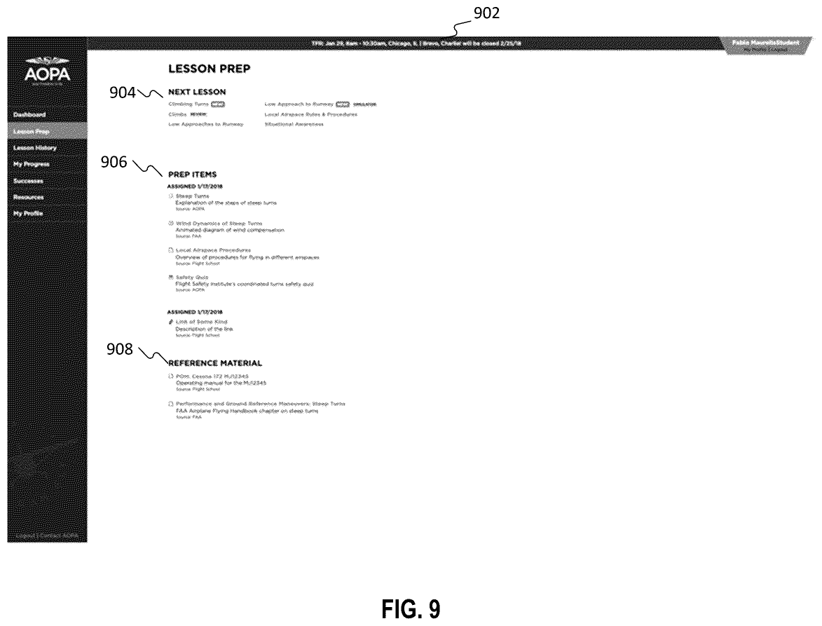

FIG. 9 is an illustration of an exemplary flight training tool lesson prep interface 902, consistent with disclosed embodiments. Lesson prep interface 902 may display information about the next lesson 904, as well as designated prep items 906, that a student should review prior to a lesson. Reference material 908 may also be provided for additional information the student may need or desire. In some embodiments, a status of the prep item, such as completed or not, maybe provided. Prep items 906 and reference items 908 may include links to display the item.

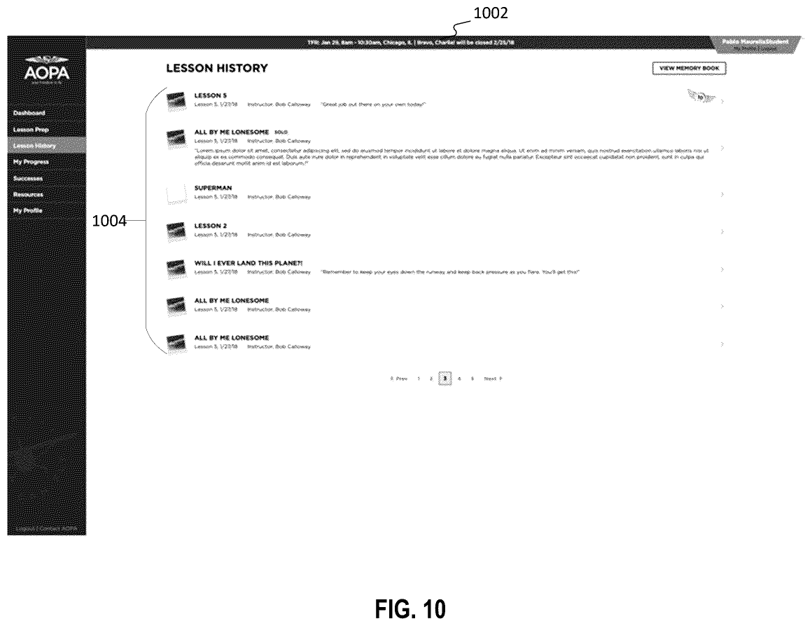

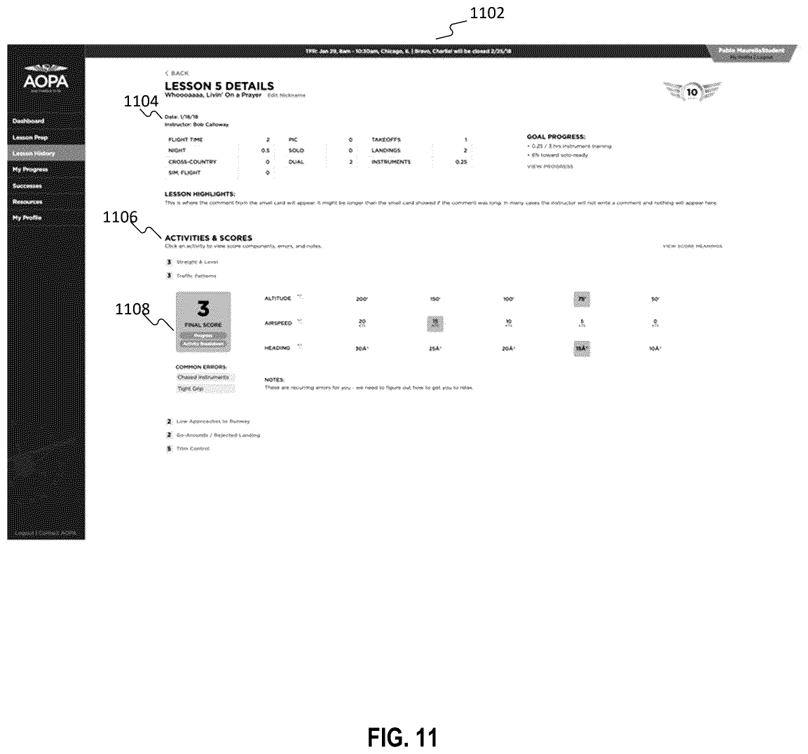

FIG. 10 is an illustration of an exemplary flight training tool lesson history interface 1002, consistent with disclosed embodiments. Lesson history interface 1002 may include a list 1004 of lessons completed by the student. In some embodiments, lessons may be selectable for reveal a flight training tool student portal lesson detail interface 1102 as shown in FIG. 11, consistent with disclosed embodiments. For example, student portal dashboard 802 may provide a link to an individual lesson to see the detail interface 1102. Detail interface 1102 may display lesson details 1104 such as a date of the lesson, a nickname of the lesson, data for each logbook criterion (e.g. flight time, night, cross country, etc.), and display overall progress for countable criteria (e.g., 1 of 3 night hours complete). Detail interface 1102 may also display activities completed 1106 and scores 1108 provided for the activities.

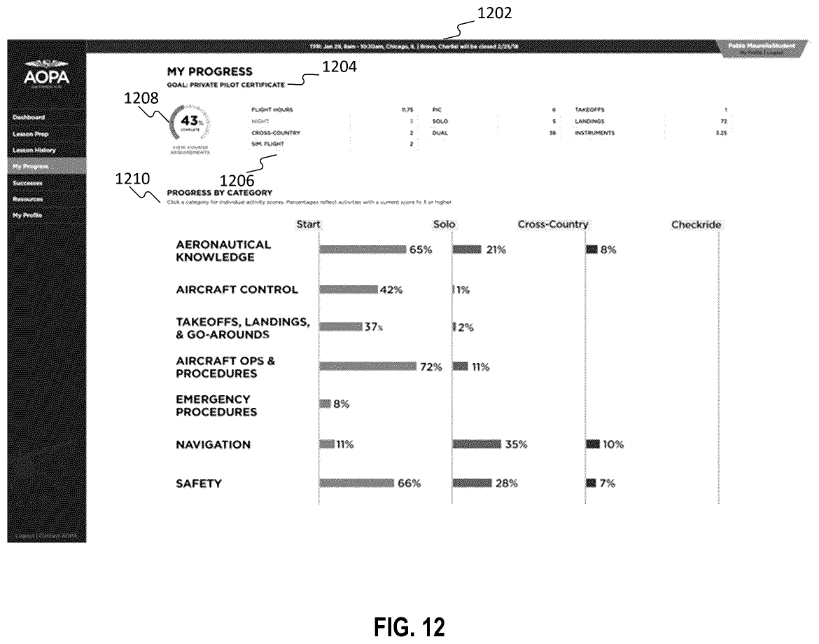

FIG. 12 is an illustration of an exemplary flight training tool student portal progress interface 1202, consistent with disclosed embodiments. For example, tracker interface 1202 may present the student's program or goal 1204 and logbook entries 1206 to inform students of their progress. Logbook entries 1206 may display information processed by flight training tool 102 as well as requirements stored in database 108 and processed by flight training tool 102. For example, logbook entries 1206 may include total flight time, night flight time (x of 3 hours, of which includes 1 cross country flight more than 100 nautical miles, 10 takeoffs and landings to a full stop, each involving a traffic pattern at an airport), cross-country time (x of 3 hours), solo time (x of 10 hours, 5 cross country hours, 1 solo cross country of at least 150 nautical miles w with 3 full stop landings at an airport with a working control tower), dual time (x of 20 hours), flight by reference to instruments (x of 3), and practical test preparation training within preceding 2 calendar months (x of 3 hours).

Progress interface 1202 may also display progress as a percentage 1208 of the student's activity completion within their goal. A student's goal may include completing training requirements, such as requirements necessary to successfully complete a lesson, to successfully complete a training course or class, to successfully qualify for a certificate or certification (e.g., FAA Airman Certification Standard), etc. Additionally, tracker interface 1202 may display progress by category 1210 within Airman Certification Standard (ACS) categories for stages of flight training (i.e., pre-solo, solo, cross-country), shown as a percentage as determined by flight training tool 102. As a student completes activities, for instance by receiving proficient scores on two consecutive occasions, tracker interface 1202 may display progress as a percentage of the activities the student has completed within each category, along with a link to display grades for individual activities.

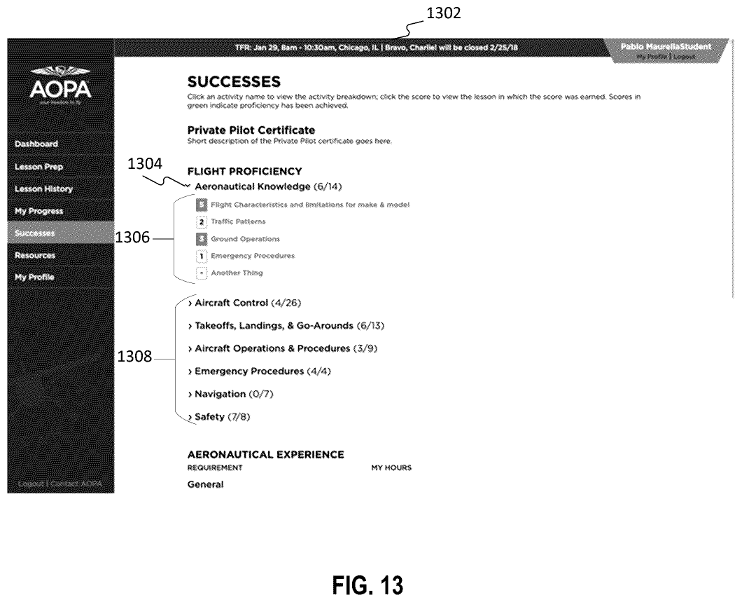

FIG. 13 is an illustration of an exemplary flight training tool student portal success interface 1302, consistent with disclosed embodiments. Success interface 1302 may be accessible from the student portal. Success interface 1302 may display a student's progress within ACS categories 1304, 1308 broken down by individual activity 1306 displayed when a corresponding category is selected. Additionally, each activity 1306 may display an activity breakdown when selected. Furthermore, ACS categories 1304, 1308 may be displayed with the number of completed and remaining activities in each category. Success interface 1302 may also provide color coding to show if a student has demonstrated proficiency for an activity. Additionally, each activity that has been attempted may be displayed with the grade the student achieved.

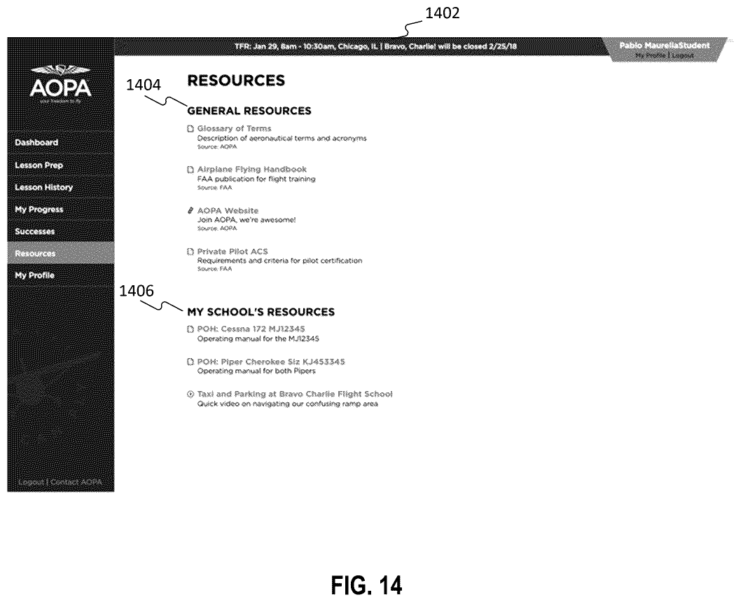

FIG. 14 is an exemplary flight training tool student resources interface 1402. Resources interface 1402 may include general resources 1404 and school-specific resources 1406.

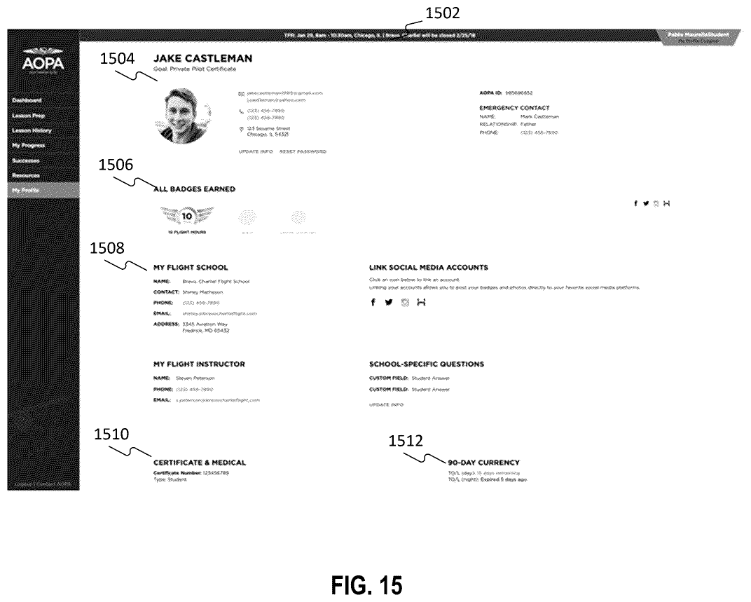

FIG. 15 is an exemplary flight training tool student profile interface 1502. Student profile interface 1502 may display student information 1504 and any badges 1506 that the student has learned. The student's school information 1508 and notifications such as certificates 1510 and currencies 1512 may also be displayed.

### CFI Portal

Flight training tool 102 may also be used to generate, maintain, host, and/or provide access to a CFI portal, consistent with disclosed embodiments. The information displayed to the CFI using the CFI portal may include information processed by flight training tool 102 and stored in database 108. A CFI may be enabled by the disclosed system to view a schedule of upcoming appointments, student profiles, and each student's previous lesson(s) and upcoming lesson by accessing data processed by flight training tool 102.

During a lesson the CFI may grade the activities and take notes. Once the lesson has concluded, the CFI may record the hours spent performing the lesson activities as depicted by the Hobbs/Tach time of the aircraft and then conduct a post-lesson briefing with the student. The post lesson briefing may include reviewing the just-finished lesson and previewing the next lesson using the grades and notes recorded in the CFI portal. The instructor may also receive a reminder to schedule the next lesson.

Each of these steps may be aided by the flight training tool 102 accessed by the CFI using a CFI portal, consistent with disclosed embodiments. Furthermore, the CFI portal may be accessed by a tablet device or other computer hardware and supported by multiple commercially-available operating systems and hardware devices (e.g., Apple iOS, iPad, Android, Windows, etc.). In some embodiments, the disclosed application may be supported by only a single category of operating systems or hardware devices.

Furthermore, the CFI portal may be configured to work offline and synchronize once connected. The CFI portal may be configured to allow CFIs to access activity support data and be able to grade each activity offline. Grading information and comments made while offline may be saved to be synchronized when reconnected to Wi-Fi.

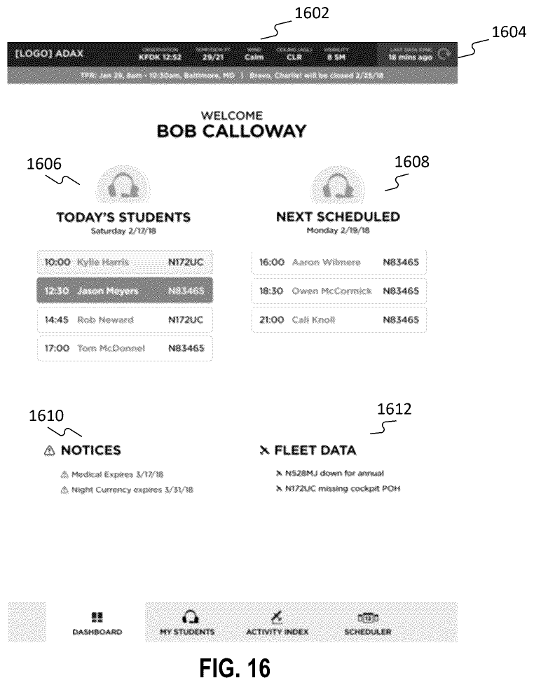

FIG. 16 is an illustration of an exemplary flight training tool CFI portal dashboard 1602, consistent with disclosed embodiments. As shown in FIG. 16, CFI dashboard 1602 may be configured to display a message bar 1604. Message bar 1604 may have the ability to display the current METAR showing weather for a pre-configured home airport, including time of last update. Additionally, there may be an area for notices, alarms, warnings, or messages (e.g. TFRs, squawks, custom messages, notices). In some embodiments, this information may only be available while on-line. When in off-line mode, a message may be displayed alerting user that the information is not available in this mode.

CFI dashboard 1602 may display a list of the day's students 1606 including date, time, and scheduled aircraft. Information displayed in the list of the day's students may be processed by flight training tool 102 by accessing scheduling tool 110. In some embodiments, if the user selects a name, information about that student's next lesson may be shown.

Similarly, CFI dashboard 1602 may also display the next work day's students 1608 with date, time, and scheduled aircraft. Information displayed in the list of the day's students may be processed by flight training tool 102 by accessing scheduling tool 110. In some embodiments, if a user selects a name, information about that student's next lesson may be shown.

CFI dashboard 1602 may also display notices 1610. The notices may include notices from a flight school, expiration dates for medicals, currency notes, etc. CFI dashboard 1602 may also show notices concerning school assets 1612, including grounded aircraft, upcoming maintenance, etc. When a notice is selected, CFI dashboard may display additional information related to the notice, such as going to a student's currency screen if there is a 90-day notice.

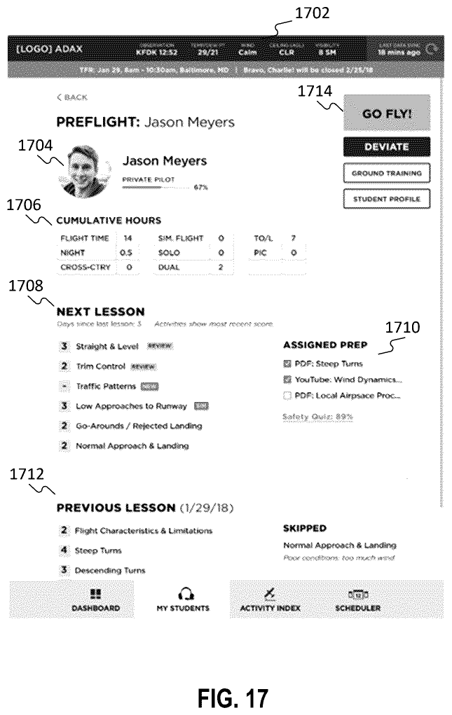

FIG. 17 is an illustration of an exemplary flight training tool CFI portal lesson view 1702, consistent with disclosed embodiments. Lesson view 1702 may be used by a CFI to begin a lesson. The CFI may begin a lesson, deviate from the lesson, record ground graining, or choose to review a student's profile.

Lesson view 1702 may include student information 1704 such as the student's name, profile picture, goal (i.e. sport pilot, recreational pilot, private pilot) and percent of completion. In this way, the CFI may validate who the lesson is for by showing the student's picture, name, and goal. Additionally, the percent complete may be a motivational tool.

Lesson view 1702 may also include the selected student's accumulated training times 1706, which may be calculated by flight training tool 102 based on information input by the CFI as part of each lesson. For example, training times 1706 may include total flight time, night flight time, cross-country time, solo time, dual time, flight reference by instruments, practical test preparation training within the preceding 2 calendar months, and total simulator time.

Lesson view 1702 may also show activities for the next lesson 1708. This may include days since last lesson to give a quick update as to how long it's been since the last flight. Lesson view 1702 may also display the previous grade for activities, if previously graded.

Lesson view 1702 may also show determined lesson preparation 1710. Determined preparation 1710 may be homework generated by flight training tool 102 for the student's next lesson. Each preparation item may be stored in a resource repository and associated with an activity. When a new activity is planned for the next lesson, the preparation items associated with that activity may be displayed in the determined preparation 1710 and be made eligible for selection. Preparation items may have a check-box that indicates if that preparation item was visited or not.

Lesson view 1702 may also display the previous lesson 1712, including the date the last lesson was flown, the activities flown, and their grades. Any skipped activities may be displayed as well, along with the reason they were skipped.

Lesson view 1702 may also provide buttons 1714 to start a lesson and proceed to the lesson grading screens. Buttons 1714 may include a button to deviate, or change, the current lesson. This option may be selected due to possible issues on the day of the lesson The deviation may change a lesson to a simulator lesson, change the date of the lesson by rescheduling, designate new preparation and/or add ground school items to the lesson so that the student can perform additional preparation ahead of the next lesson. Buttons 1714 may also include a button to record ground training. A ground training button may allow an instructor to record any ground school training offered that day. In some embodiments, the ground training button does not affect the originally planned lesson, which may remain as the next lesson. Buttons 1714 may also include a button to go to the student profile.

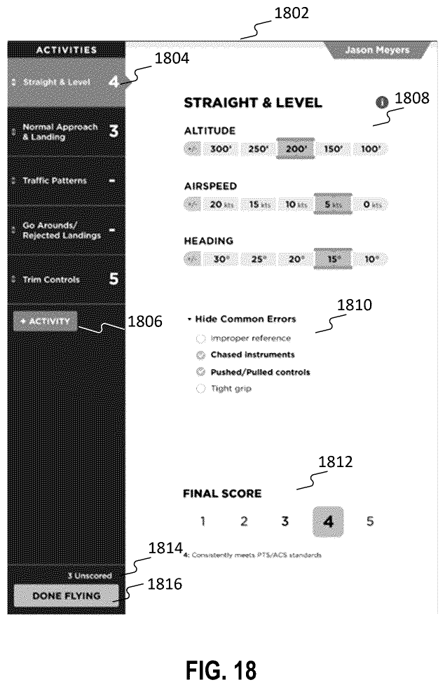

FIG. 18 is an illustration of an exemplary flight training tool CFI portal lesson grading interface 1802, consistent with disclosed embodiments. Grading screen 1802 may be used by a CFI to grade activities during a lesson.

Grading interface 1802 may be used by a CFI during a flight and show activities 1804 that are easily accessible with minimal effort to see each one. Since the cockpit is a challenging environment, the activities 1804 to be graded need to be easily seen and accessible. Activities 1804 to be graded may be viewable in list form. Activities may show a corresponding grade if the CFI has provided it, and can be moved up or down the list. Grading screen 1802 may also include an add activity button 1806. For example, a CFI may decide that activities should be added during a lesson. In some embodiments, pressing the add activity button 1806 may cause an additional screen to display with all activities by category, with search and filter functionality.

When an activity is selected, grading screen 1802 displays grading information. When a CFI selects an activity to grade, corresponding grading criteria appears. The activity name, grading criteria 1808, common errors 1810, and final grade 1812 may be displayed on grading screen 1802. The grading criteria 1808 may be sliders. Criteria may include altitude (ft+/−), airspeed (kts+/−) and heading (degrees+/−). Grading criteria for each activity may be set out in the ACS. In other embodiments, grading criteria may be adopted from another organization, standard, or other resources. The CFI may select the appropriate grade, for example, on a scale of 1-5, based on the student's performance on that activity. When the final grade is selected, the definition of the selected grade may be displayed.

Each activity may have common errors 1810, documented within the activity breakdown. Due to the realities of the cockpit environment, typing is not the best form of input for pilots to use. In view of this challenge, grading screen 1802 may be configured to list the common errors as check-boxes so that the instructor can select one or more from the list if they apply to the student's performance.

Grading screen 1802 may also show a real-time unscored activity indicator 1814. Grading screen 1802 may also have a button to complete the lesson 1816. In some embodiments, the instructor may not be able to close the lesson without acknowledging the items that were skipped and providing a reason.

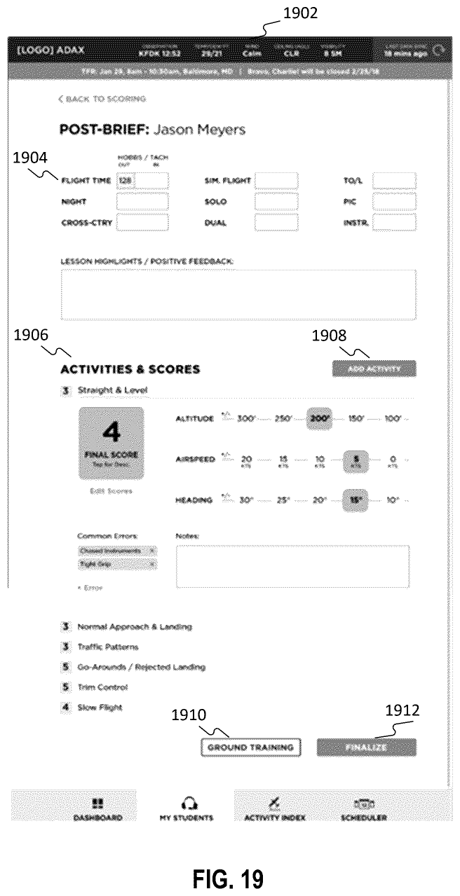

FIG. 19 is an illustration of an exemplary flight training tool CFI portal post brief interface 1902, consistent with disclosed embodiments. A CFI may use post brief interface 1902 to review the lesson, grades, and any comments about how the lesson went.

Post brief interface 1902 may provide a logbook entry area 1904 for recording times for the flight lesson, including times for flight, night, cross country, solo, dual, instruments, simulator, practical test preparation, and pilot-in-charge. Logbook entry area 1904 may also record the number of landings performed. Upon finishing the lesson, post brief interface 1902 may allow the instructor to fill in logbook entries pertaining to the recently completed flight. The logbook entries may differ depending on goal, such as recreational or sport pilot certificate.

Post brief interface 1902 may also provide activities and scores 1906, including an overall score, for the lesson. Common errors, notes, and skipped activities may also be displayed. Post brief interface 1902 may include a list view of the graded activities, and each activity may be clickable to show a detailed view allowing a CFI to provide notes. Activities that have not been graded may be labeled as “No Grade,” post brief interface 1902 may provide the CFI the ability to grade or skip the activity. Post brief interface 1902 may also provide a mechanism to repeat reasons that an activity was skipped for all remaining ungraded activities. Activities may display options to add a score or a reason for skipping the activity. Additionally, post brief interface 1902 may include a button to add an activity 1908 that was performed during the flight but was not previously listed in the activities listing. Post brief interface 1902 may include an option to add ground training 1910, as well. A finalize button 1912 may also be provided. When selected, finalize button 1912 may check the data entered by the CFI for any errors such as ungraded or skipped activities. Furthermore, finalize button 1912 may initiate the process illustrated in FIG. 4 to set a state to activities in the lesson.

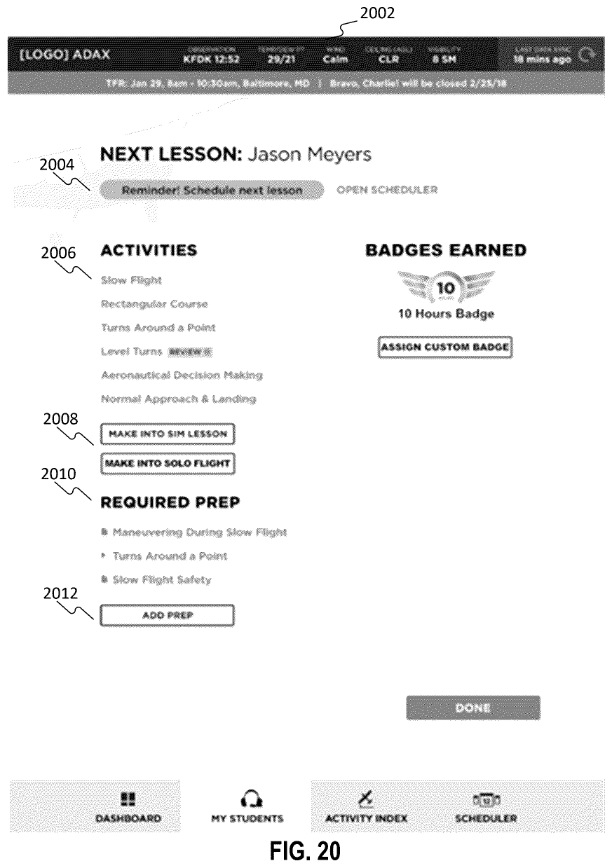

After a lesson is finalized, the flight training tool CFI portal may display a next lesson interface 2002 as shown in FIG. 20 and consistent with disclosed embodiments. Next lesson interface 2002 may display a next lesson automatically generated by flight training tool 102.

Next lesson interface 2002 may also provide an option to schedule the next lesson 2004. In some embodiments, option 2004 may be prominently displayed so that even before reviewing the next lesson, the student is booked for the next lesson. In this way, flight training tool 102 may ensure that the next lesson is scheduled for a student before he leaves the school, helping to retain students because they are more likely to return and continue their training when the next lesson is scheduled before they leave the school. Option 2004 may take the instructor to the scheduler to see the schedule and book a plane for the next lesson.

Next lesson interface 2002 may also display the activities selected for the next lesson 2006 with links to the activity breakdown. In some embodiments, activities may be labeled new, review, simulator, or skipped as appropriate.

Next lesson interface 2002 may also provide a button to make the lesson a simulator lesson 2008. Based on the lesson generated, the instructor may decide to complete the lesson in a simulator. Simulator lesson button 2008 may allow converting a planned flight lesson to a simulator lesson without leaving the next lesson interface 2002. Completing the lesson in a simulator may result in it being recorded only as a simulator lesson while not counting toward flight hours or changing the “next lesson”. The next lesson may remain as prescribed until it is flown.

Next lesson interface 2002 may also display the next lesson preparation 2010. Next lesson preparation 2010 may be based on the generated next lesson and proposed as a way of introducing the student to the upcoming activities. Each flight school may have its own lesson preparation materials, which it can add to the list of determined preparation materials by clicking on an “Add Prep” button 2012.

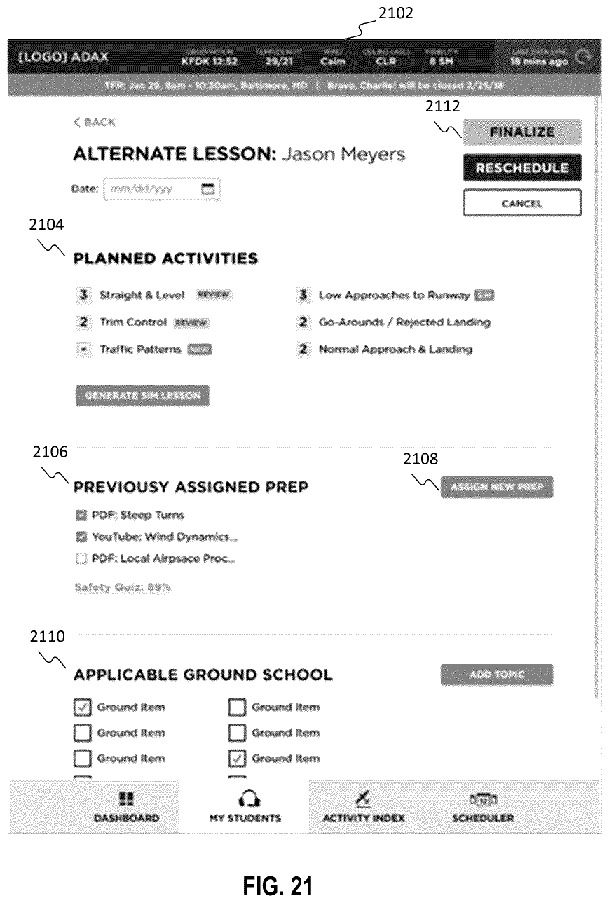

In some situations, a CFI may choose to deviate from the planned lesson, for instance, by selecting a deviate button as illustrated in FIG. 17 due to weather, maintenance, or other issues. If the lesson was deviated, flight training tool CFI portal alternate lesson interface 2102, as shown in FIG. 21, may be used by the CFI to grade the lesson. For example, alternate lesson interface may enable the CFI to choose simulator or ground instruction, determine additional lesson prep, and schedule the next lesson. Alternate lesson interface 2102 may display planned activities 2104, and planned rollover activities may show the previous lesson's grade. Planned activities may be labeled with an appropriate label such as new, skip, etc.

Alternate lesson interface 2102 may also display previously determined lesson preparation 2106. Determined lesson preparation items may be displayed with a check mark or empty check box to denote whether or not the link to the preparation item had been clicked through. Alternate lesson interface 2102 may also provide a button for the instructor to add extra material to the lesson preparation determined by flight training tool 102. Alternate lesson interface 2102 may also display a list of applicable ground school items 2110. Ground school items 2110 may be displayed by category. Ground school items may have a check box that can be used by the instructor to signify what topics were covered in that lesson.

Alternate lesson interface 2102 may also display a button 2112 to finalize the alternate lesson. Once the alternate plan has been chosen, finalize button 2112 may generate a new lesson preparation and record ground school items. The previously planned activities may remain the same for the next flight lesson. A pop-up window may also appear so that the instructor may enter the number of ground school and simulator hours that occurred during this session.

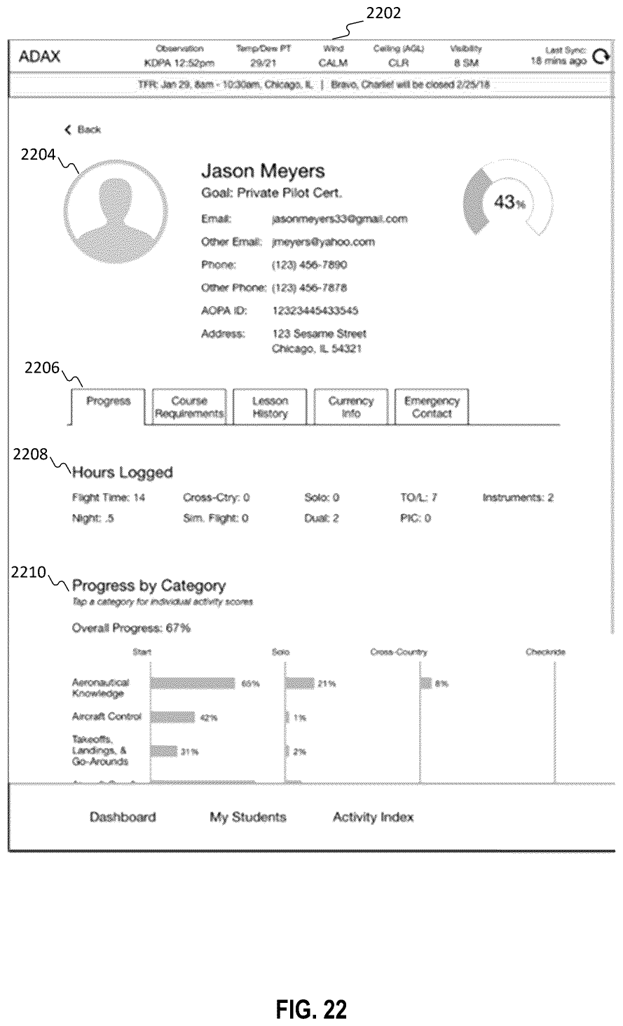

FIG. 22 is an illustration of an exemplary flight training tool CFI portal student profile and progress display interface 2202, consistent with disclosed embodiments. The student's goal, lesson history, currency, and medical information may be displayed on student profile interface 2202. Student profile interface 2202 may be used as a motivational tool and preparatory tool to show students how far students have progressed and what is remaining. For instance, student profile interface 2202 may display general student information 2204 including a profile photo, name, goal, email, phone number, AOPA ID, address, alternate email and phone number, emergency contact name, relationship, and phone number, goal progress as a percentage.

Progress display interface 2202 may also display informational tabs. For example, progress display interface 2202 may display a progress tab 2206, including information related to recorded training time 2208 such as hours logged for total flight time, night flight time, cross-country time, solo time, dual time, flight by reference to instruments, and practical test preparation training. Progress information 2210 may be based on the goal that the particular student is pursuing, such as recreational or sport pilot certificates. Simulator time may also be displayed in progress tab 2206. Furthermore, progress by category and by stage may be displayed as percentages.

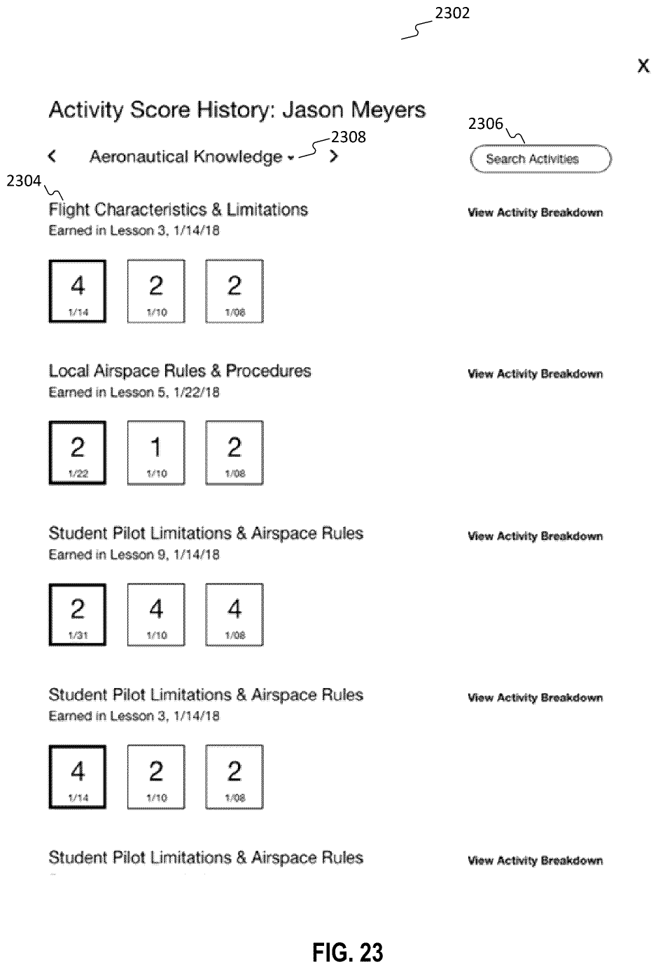

In some embodiments, the CFI portal may also provide the CFI the ability to open activity history from the progress display interface 2202, as shown in FIG. 23. FIG. 23 is an illustration of an exemplary flight training tool CFI portal activity score history interface 2302, consistent with disclosed embodiments. History interface 2302 may display category history 2304. A search box 2306 may be provided to search for specific activities. Activities may be displayed by category as selected by category dropdown 2308. Activities may be displayed with grades and dates of when the activity was practiced.

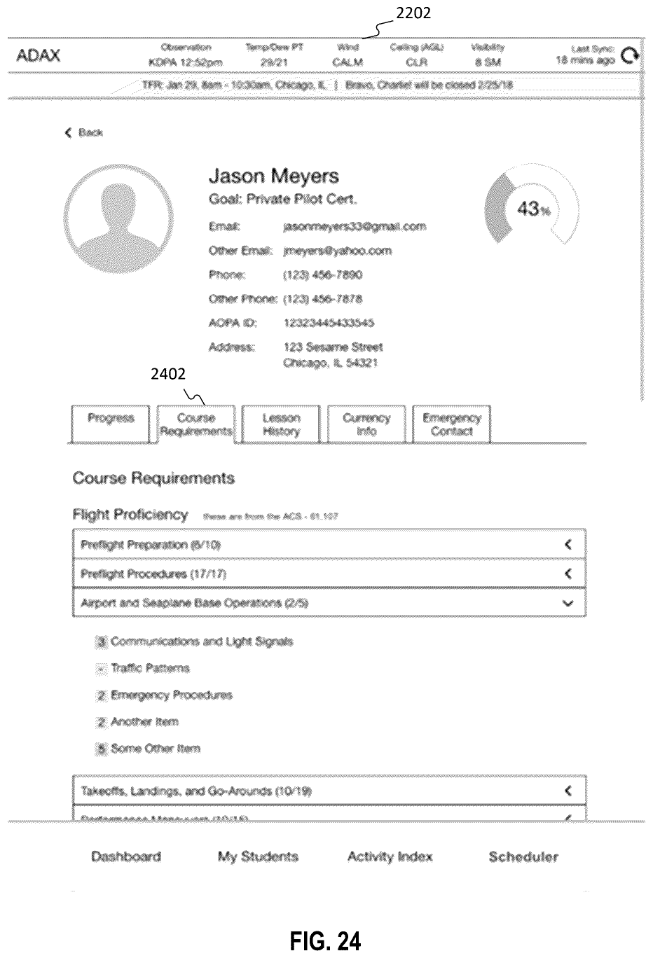

Student profile interface 2202 may also provide a course requirement tab 2402 as shown in FIG. 24, consistent with disclosed embodiments. The course requirements tab displays all activities within the student's goal. Requirements for achieving the goal (e.g. private pilot) may be listed by category. Within each category are activities with boxes to show proficiency/completion. The category title may also show the number of activities completed out of the total number of activities (e.g., x of y). Within each checkbox the last grade received may be displayed along with a color shade to display proficiency. If the student is considered proficient in the activity, then the check box may be colored green and display the last grade received. If the student is not yet proficient, the grade is displayed. The box may also be empty if the activity has not been attempted yet.

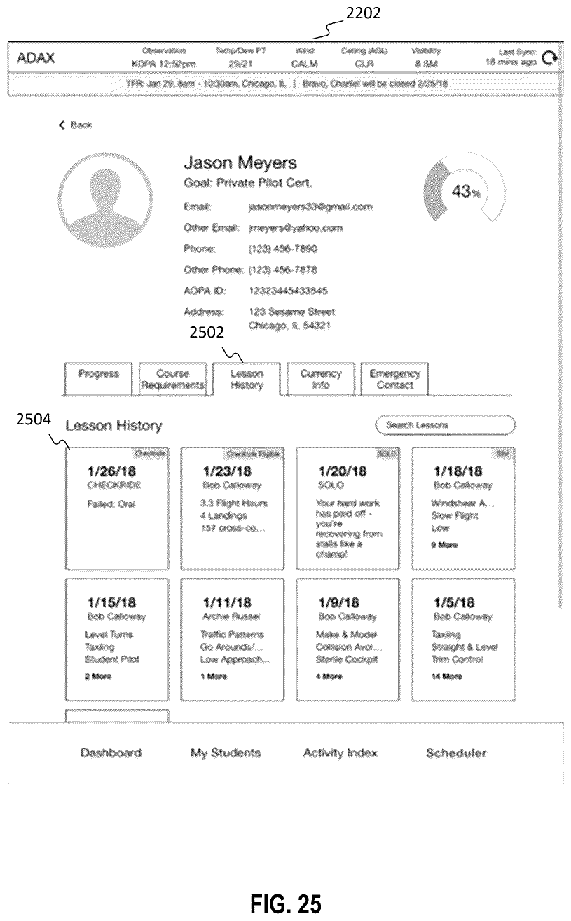

Student profile interface 2202 may also provide a lesson history tab 2502 as shown in FIG. 25, consistent with disclosed embodiments. The lesson history tab may display a history of lessons by date. For example, lessons may be displayed as tiles 2504. Each tile may display lesson name, lesson tags such as solo, simulator, cross country, night, stage, etc., lesson date, CFI name, a lesson memory, or lesson activities.

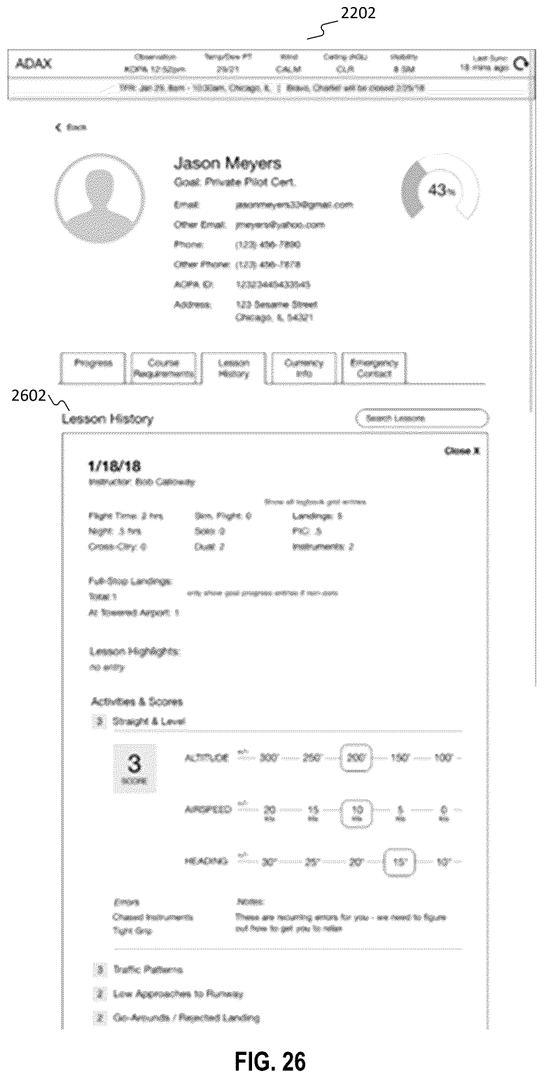

Furthermore, each tile may be clickable to show a lesson history detail view 2602 as illustrated in FIG. 26 consistent with disclosed embodiments. The detail view may include a lesson's date, instructor name, logbook totals including flight time, night time, cross country time, solo time, dual time, time flying by reference to instruments, and practical test preparation time, or other requirements as appropriate for students providing other goals. Simulator time may also be displayed. Activities, grades, lesson highlights, and grading notes may also be displayed in the lesson history detail view 2602.

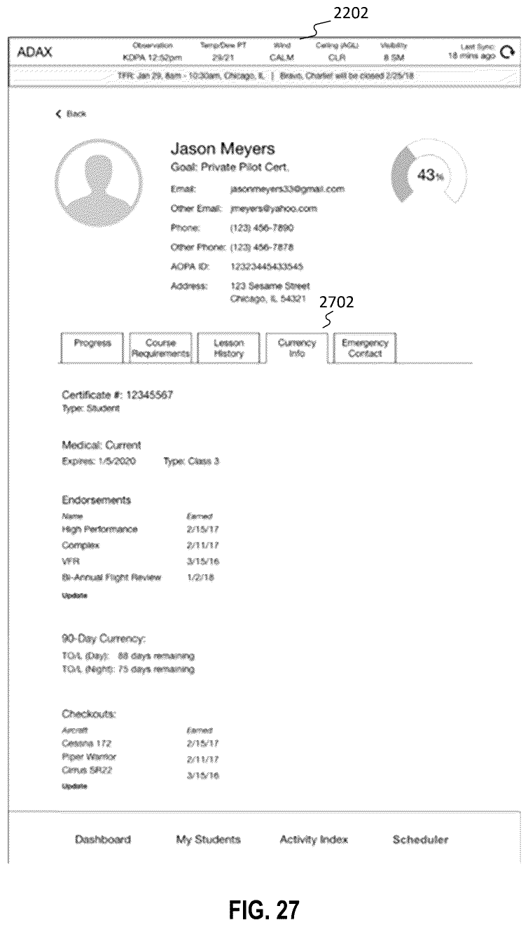

Student profile interface 2202 may also provide a currency information tab 2702 as shown in FIG. 27, consistent with disclosed embodiments. Currency information tab 2702 may display FAA data, airplane currency, and airplane checkouts. For example, the currency information tab 2702 may include student certificate number, current medical data, type of certificate, endorsements, and checkouts.

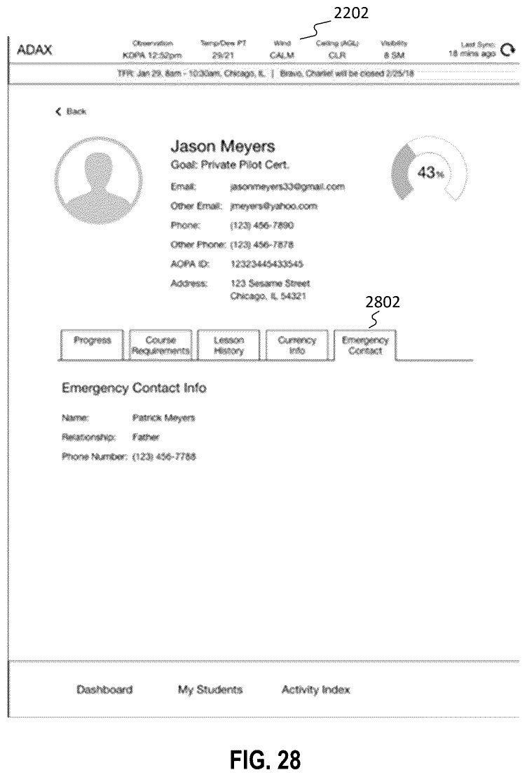

Student profile interface 2202 may also provide an emergency information tab 2802 as shown in FIG. 28, consistent with disclosed embodiments. Emergency information tab 2802 may include emergency contact information for the student, such as a name, relationship, and phone number.

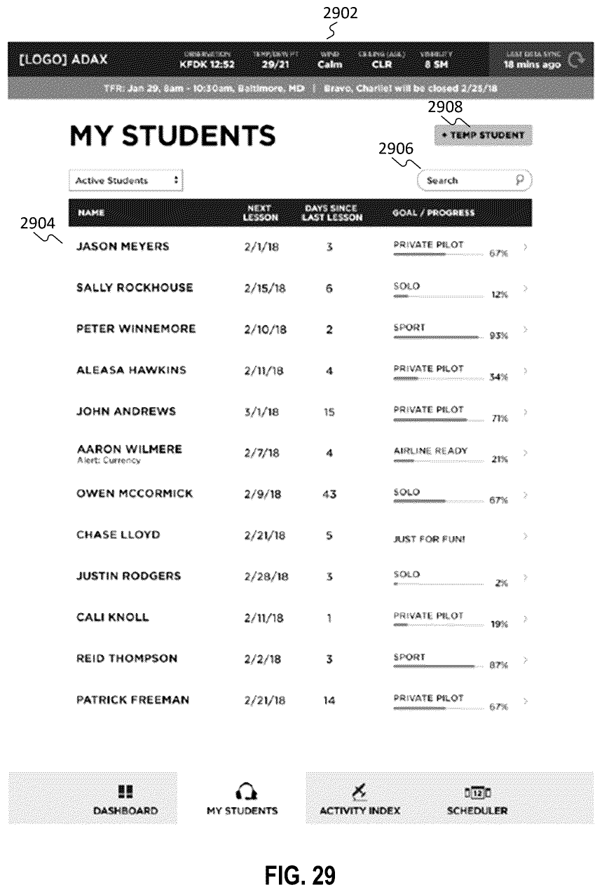

The flight training tool CFI portal may also include a student list interface 2902 as shown in FIG. 29, consistent with disclosed embodiments. Student list interface 2902 may display a list 2904 of all the students at the school. Students may have a label or tag for alerts or milestones, and may be filtered by instructor. Additionally, student list 2902 may include a student search function 2906. Student list interface 2902 may also include a temporary student button 2908. The temporary student button 2908 may be used when a student switches from being paired with one CFI to another CFI. When the new CFI selects temporary student button 2908, the CFI may select a student from the list of students at the school for a single lesson. Student list interface may also display students' names, next lesson dates, numbers of days since last lesson, goals, and percentages complete.

The flight training tool CFI portal may provide an activity index 3002. Activity index may display categories 3006 of activities 3004. When a category 3006 is selected, the activities 3004 in the category may be displayed.

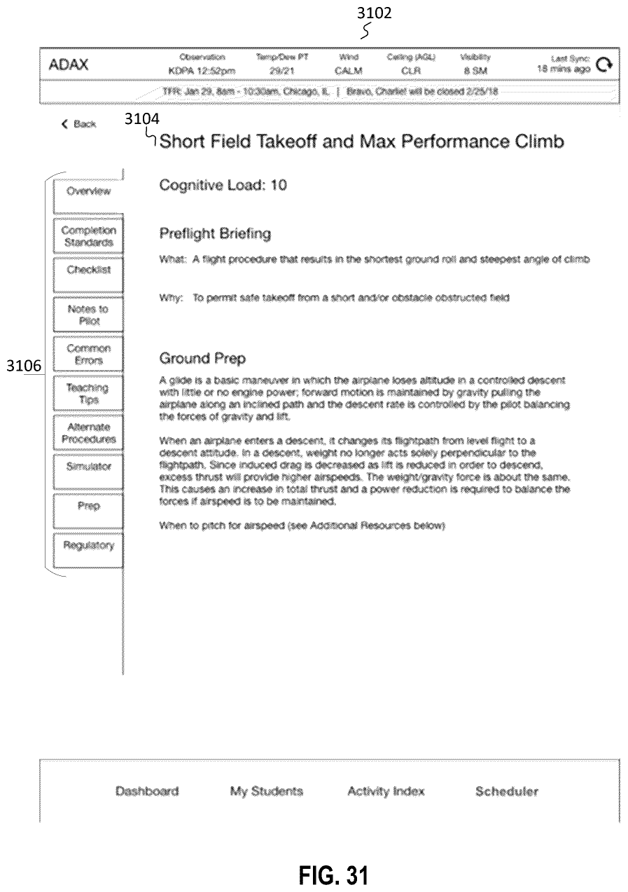

FIG. 31 is an illustration of an exemplary CFI portal activity detail interface 3102, consistent with disclosed embodiments. Activity detail interface 3102 may include additional information on a selected activity 3104 organized in tabs 3106. For example, tabs 3106 may include an overview, completion standards, checklist, notices to pilot, common errors, teaching tips, alternate procedures, simulator, prep, and regulatory information.

### School Portal

Flight training tool 102 analysis and data may be also accessed by a flight training school operator using, for example, web portal 104. Through web portal 104, flight training tool 102 may provide a school portal to a flight school. The information displayed to a school user using the school portal may include information processed by flight training tool 102 and stored in database 108.

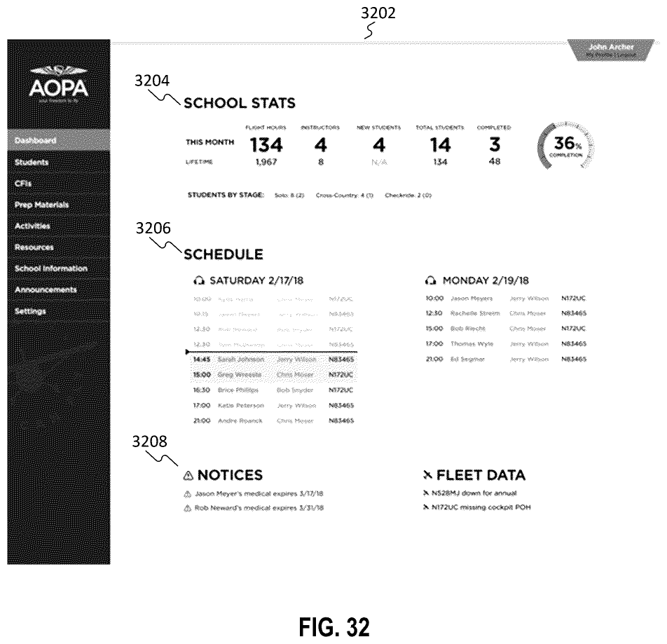

The flight school portal may be further understood by reference to FIG. 32 showing an illustration of an exemplary flight training tool school portal dashboard 3202, consistent with disclosed embodiments. School dashboard 3202 may display statistics 3204 for the school, including a number of new students, a total number of students within the school, a number of instructors within the school, a total flight hours of training for all students within the school, a total number of students who have completed their individual goals, and a completion percentage showing the percentage of active students at the school who have completed their goals. School dashboard 3202 may also provide a filter function that allows the school to see stats monthly, quarterly, annually, or for a specified date range.

Statistics 3204 may also display student stats by stage (e.g. the solo stage, cross country, or checkride preparation stages of the private pilot goal) as determined by flight training tool 102 based on the student's successful completion of appropriate stage checks. Statistics 3204 may also display a number of active and inactive students, where an active student is one that has taken training within the past 90 days, for instance.

School dashboard 3204 may also display a schedule 3206. Schedule 3206 may include the current day's students and date, and a student's name may be selected to reveal the student's profile. Furthermore, schedule 3206 may include the time of flight, student name, CFI name, aircraft, and location for schools with more than one. Additionally, schedule 3206 may include the next work day's students, date, time of flight, student name, CFI name, aircraft, and location if applicable.

School dashboard may display notices 3208. The information presented in noticed 3208 may pertain to currency, endorsements, checkouts, medical, and aircraft status. and any other paperwork subject to expiration. Notices 3208 may include notices for CFIs and students.

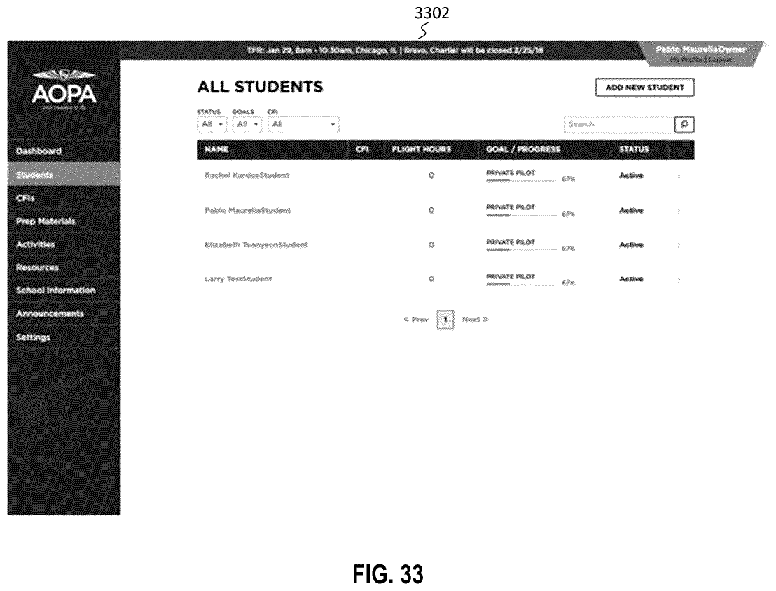

FIG. 33 is an illustration of an exemplary flight training tool school portal student list interface 3302, consistent with disclosed embodiments. The school portal student list interface 3302 allows the school to take a closer look at students. The student view may allow searching by student name and filtering by instructor, program, location, and status. School portal student list interface 3302 may display students, and student listings may be clickable to a student's profile. Data including student name, CFI name, next lesson date, total flight hours, goal, progress, and status may be displayed for students.

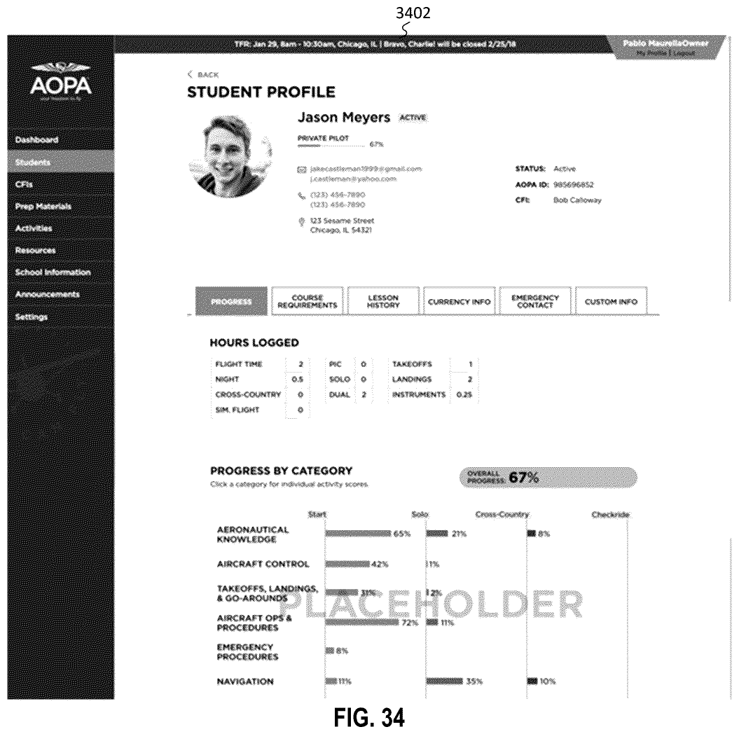

If a student is selected from school portal student list interface 3302, the flight training tool school portal may generate a detailed student profile 3402 as illustrated in FIG. 34. Detailed student profile 3402 may include information showing progress of the student and provide interfaces similar to those illustrated in FIGS. 22-28. Additionally, detailed student profile 3402 may include a tab for custom information.

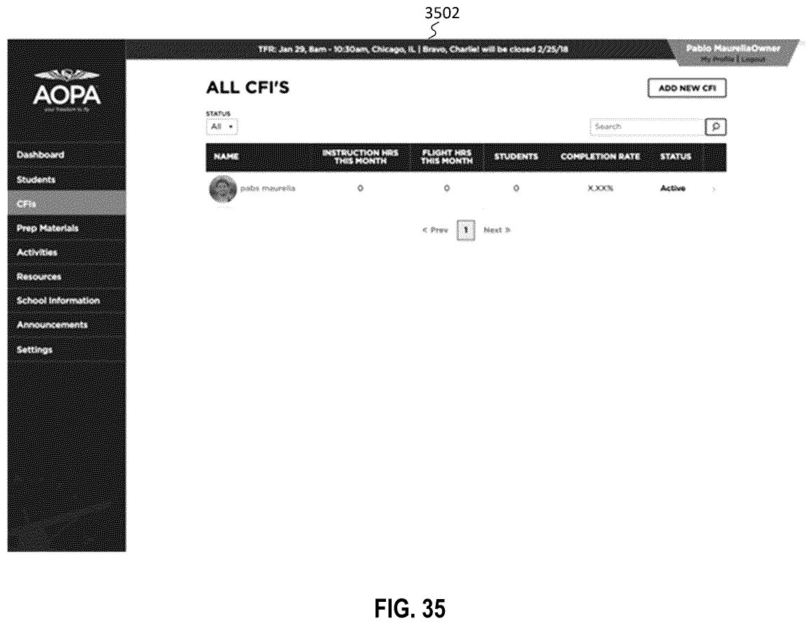

The flight training tool school portal may also provide a CFI list interface as shown in FIG. 35. CFI list interface 3502 may show all the school's instructors in a list view, including statistics for instructors. The CFI list may be searchable by name and filterable by status (active or inactive). CFI list interface 3502 may display name, instruction hours this month, flight hours this month, students, completion rate as determined by number of total students and number of students who have achieved their goals for a given period, and status. Instruction hours may be calculated by the system based on flight and ground hours entered by the CFI in student records.

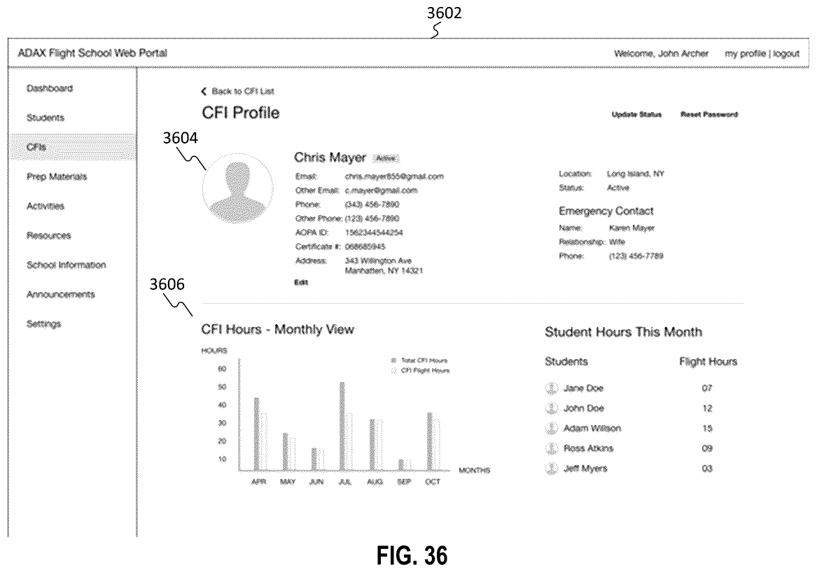

If an instructor is selected from CFI list interface 3502, the flight training tool school portal may generate a CFI profile interface 3602 as illustrated in FIG. 36. CFI profile interface 3602 may present details 3604 such as name, status (active or inactive), email, phone, AOPA ID, address, and CFI school location. CFI profile interface 3602 may also display CFI hours history 3606, such as CFI monthly hours/flight hours, and flight hours by student.

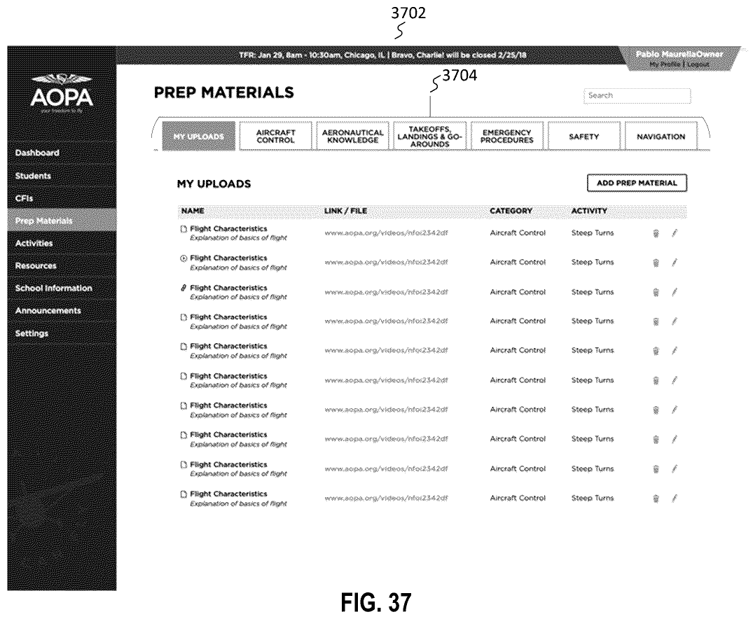

FIG. 37 is an illustration of an exemplary flight training tool school portal preparatory materials interface 3702, consistent with disclosed embodiments. A school may use preparatory materials interface 3702 to enter additional lesson preparation materials that they would like to be made available when flight training tool 102 determines lesson preparation. Preparation materials may be associated or linked with a tab 3704, such as aircraft control, aeronautical knowledge, takeoffs, landings and go-arounds, emergency procedures, safety, navigation, and a my uploads tab. The preparation materials may also display document type, number link, category, and an associated activity.

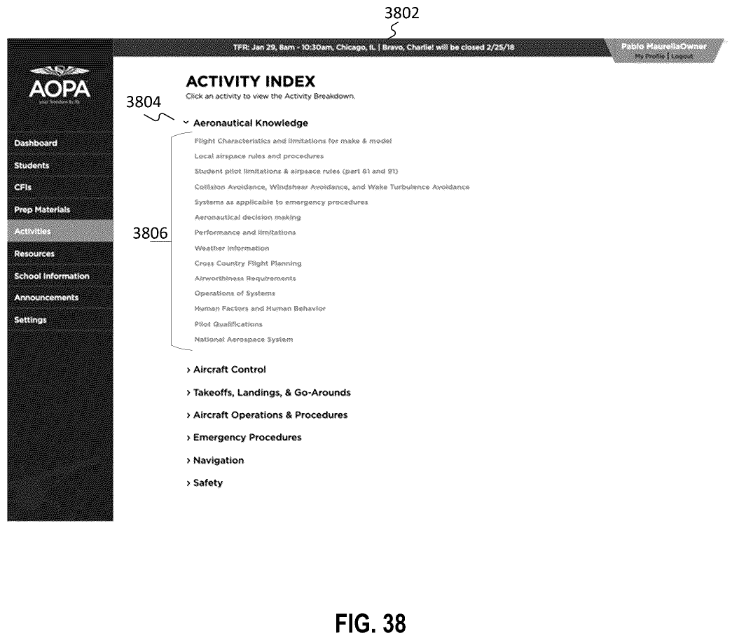

FIG. 38 is an illustration of an exemplary flight training tool school portal activity index interface 3802, consistent with disclosed embodiments. Activity index interface 3802 may show activities organized by category 3804. Additionally, when a category of activities is selected, activities 3806 in the category may be displayed. Activities 3806 may be selected to display activity details.

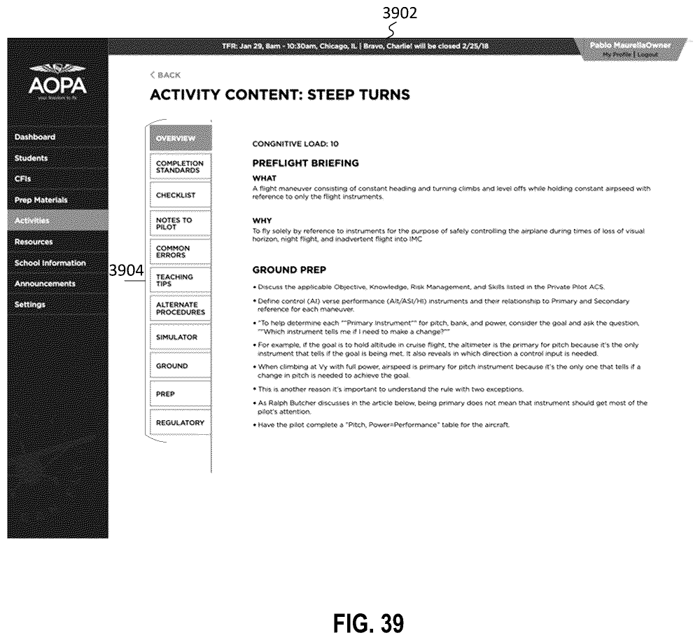

FIG. 39 is an illustration of an exemplary flight training tool school portal activity detail 3902, consistent with disclosed embodiments. Activity detail 3902 may provide additional information on teaching and performing an activity. Activity detail 3902 may include tabs 3904 including an overview, completion standards, checklist, notes to pilot, common errors, teaching tips, alternate procedures, simulator, ground, prep, and regulatory information.

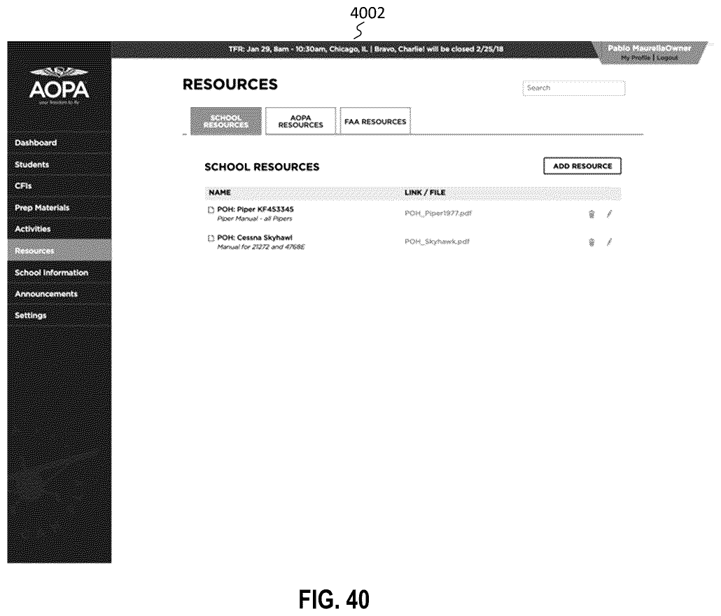

FIG. 40 is an illustration of an exemplary flight training tool school portal resources interface 4002, consistent with disclosed embodiments. Resources available to the student may be displayed here, and may include resources such as materials not designated as prep, for instance, the FAA ACS. Each resource owner, such as the school, AOPA, FAA, etc. may have its own tab.

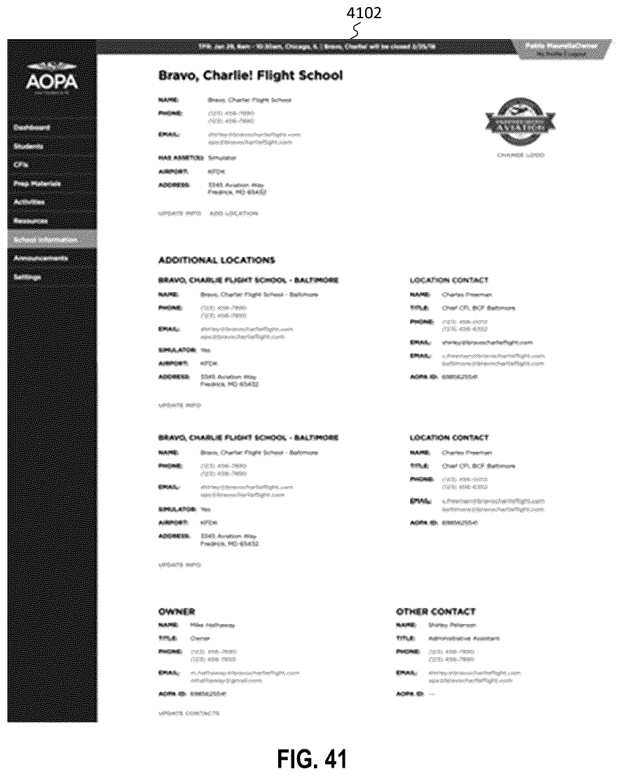

FIG. 41 is an illustration of an exemplary flight training tool school portal school information interface 4102, consistent with disclosed embodiments. School information interface 4102 may present school information, owner information, contact information, links, assets, and system users.

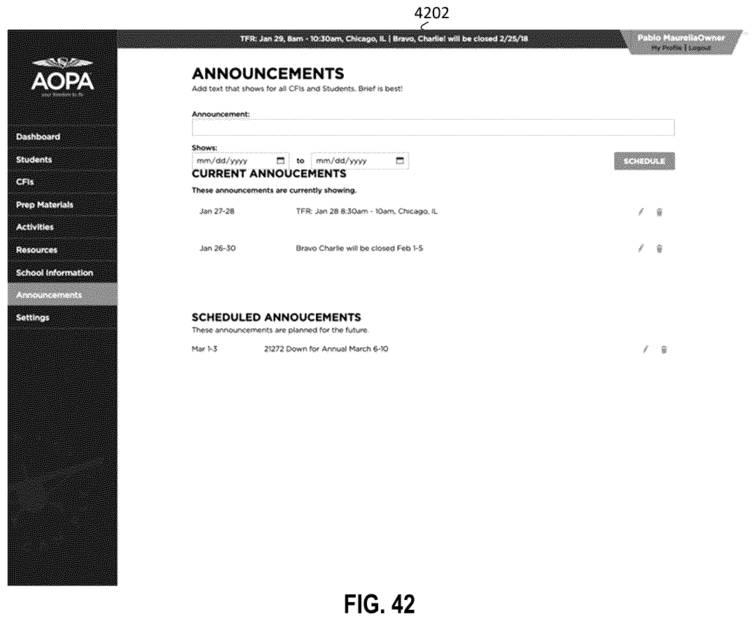

FIG. 42 is an illustration of an exemplary flight training tool school portal announcements interface 4202, consistent with disclosed embodiments. A school may have the ability to display custom messages on the home screen within the message display area. Announcements interface 4202 may be used to specify the custom message and when to show the message.

### Administrator Portal

Flight training tool 102 analysis and data may be also accessed by an administrator using, for example, web portal 104. Through web portal 104, flight training tool 102 may provide an administrator portal. The information displayed to an administrator using the administrator portal may include information processed by flight training tool 102 and stored in database 108.

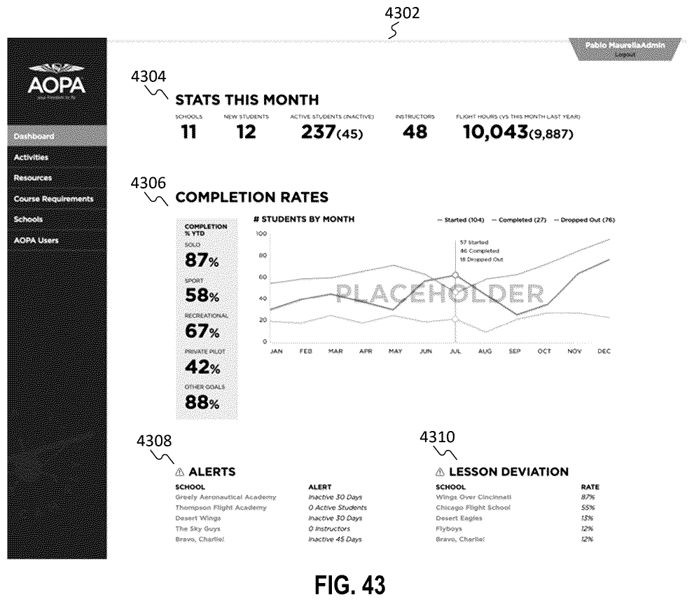

The flight training tool administrator portal may be further understood by reference to FIG. 43 showing an illustration of an exemplary flight training tool administrator dashboard 4302, consistent with disclosed embodiments. Administrator dashboard 4302 may display statistics 4304 for schools using the flight training tool. Statistics 4304 may include current statistics aggregated for all users, such as a total number of schools currently using instances of flight training tool 102, a total number of active students, a total number of new students during the current month, a total number of inactive students, a total number of instructors, a total number of flight hours logged in the current month, and a number of flight hours logged in the same month the previous year.

Administrator dashboard 4302 may also display completion rates 4306 as percentages, and include solo, sport pilot certificates, recreational pilot certificates, and private pilot certificates. Completion rates 4306 may be displayed with a trend graph of student completion by month for the past year, a total number of students who initiated training for any goal in each month for the past year, a total number of students who have achieved their goal in each month for the past year, and a total number of students who have been labeled inactive in each month for the past year.

Administrator dashboard 4302 may also display alerts 4308. Possible alerts include inactive schools, schools with no active instructors, schools with no active students, and schools with no listed assets. Selecting the school name may provide the user with a school profile page.

Administrator dashboard 4302 may also display lesson deviation 4310 showing schools that have the highest lesson deviation rate. Lesson deviation 4310 may include school names and a percentage of lessons that include deviations. Selecting a school name may provide the user with a school profile page.

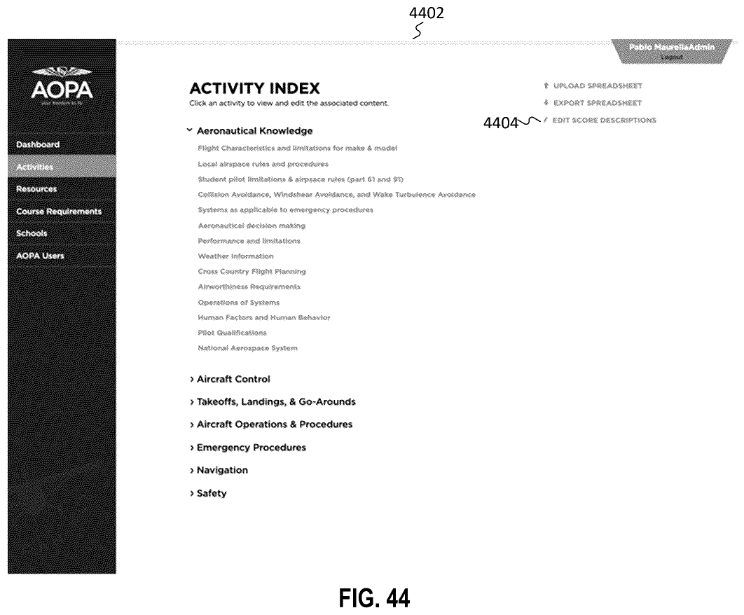

Flight training tool administrator portal may also provide an activity index 4402 as shown in FIG. 44. Activity index 4402 may list all activities processed by flight training tool 102. Activity index 4402 may provide tools to update, upload, and export activities. For example, activity index 4402 may include a button that allows an administrator to upload a new activity or generate new revised versions of existing activities. This may allow an administrator to make changes when the FAA changes requirements, for instance. Activity index 4402 may also provide a mechanism that allows an administrator to delete or hide any activity from the activity list. This may allow an administrator to add replacement items while preserving the original items within the activity list when the FAA changes requirements.

Activity index 4402 may also include a button to edit score descriptions 4404. Score description edit button 4404 may provide fields to edit grade descriptions.

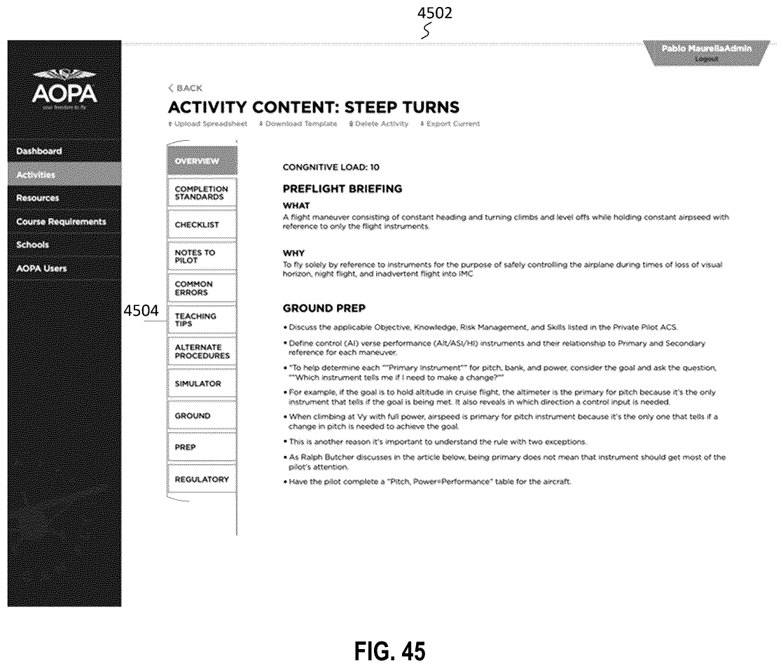

Furthermore, when an activity listed in activity index 4402 is selected, a flight training tool administrator portal activity details page 4502 may be displayed as illustrated in FIG. 45. For example, activity details page 4502 may include tabs 4504 that include information about the activity. Tabs 4504 may provide additional information on the activity, such as overview, completion standards, checklist, notes, common errors, teaching tips, alternate procedures, simulator, ground school, preparatory materials, and regulatory standards.

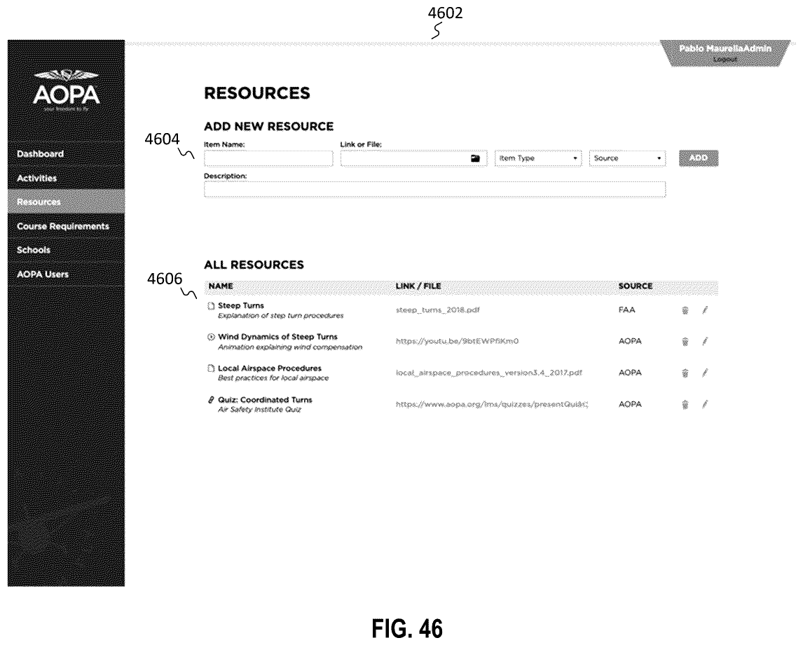

FIG. 46 is an illustration of an exemplary flight training tool administrator portal resources interface 4602, consistent with disclosed embodiments. An administrator may use resources interface 4602 to add resources that may be distributed to all flight training schools using flight training tool 102. Resources interface 4602 may include fields 4604 to add additional resources, including lesson preparation and reference materials, to the flight training tool resource library. Resources interface 4602 may also include an all resources section 4606 showing all resources in the resource library.

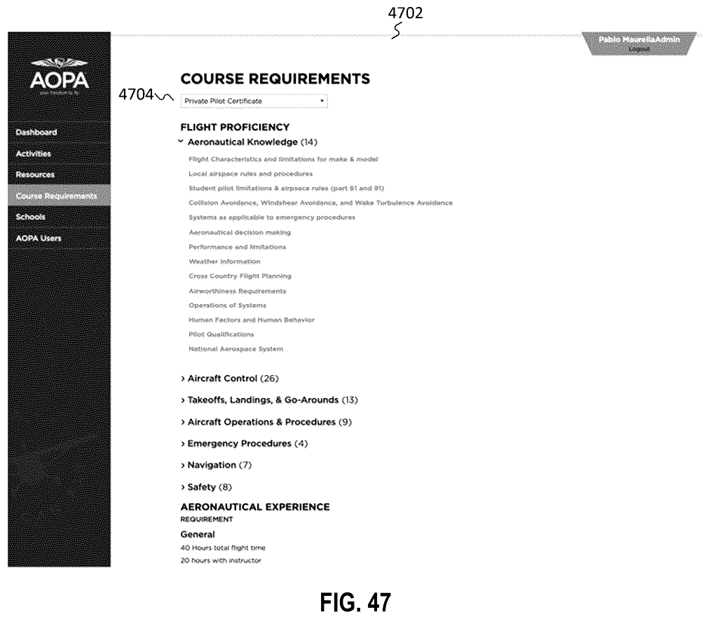

FIG. 47 is an illustration of an exemplary flight training tool administrator portal course requirements interface 4702, consistent with disclosed embodiments. Course requirements interface 4702 may display a drop-down menu of possible goals 4704, including solo, sport pilot, recreational pilot, and private pilot. When an item is selected from drop-down menu 4704, course requirements interface 4702 may display associated ACS requirements, including the number of activities and a list of the activities. When an activity is selected, an activity breakdown may be displayed.

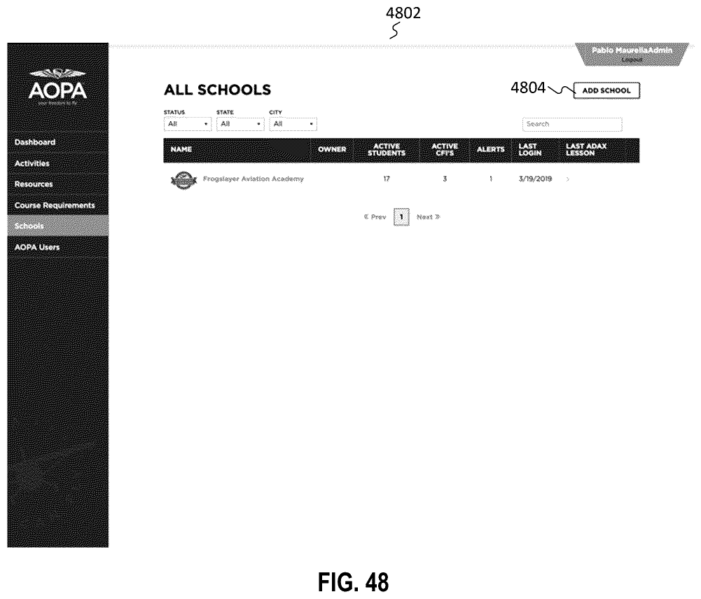

FIG. 48 is an illustration of an exemplary flight training tool administrator portal school list interface 4802, consistent with disclosed embodiments. School list interface 4802 may show a list of schools in a flight training network and have sortable columns including name of school, school owner name, number of active students, number of active CFIs, number of alerts, last login of school, and last lesson created by flight training tool 102. An add school button 4804 may also be included to allow an administrator to enter details for an additional flight school.

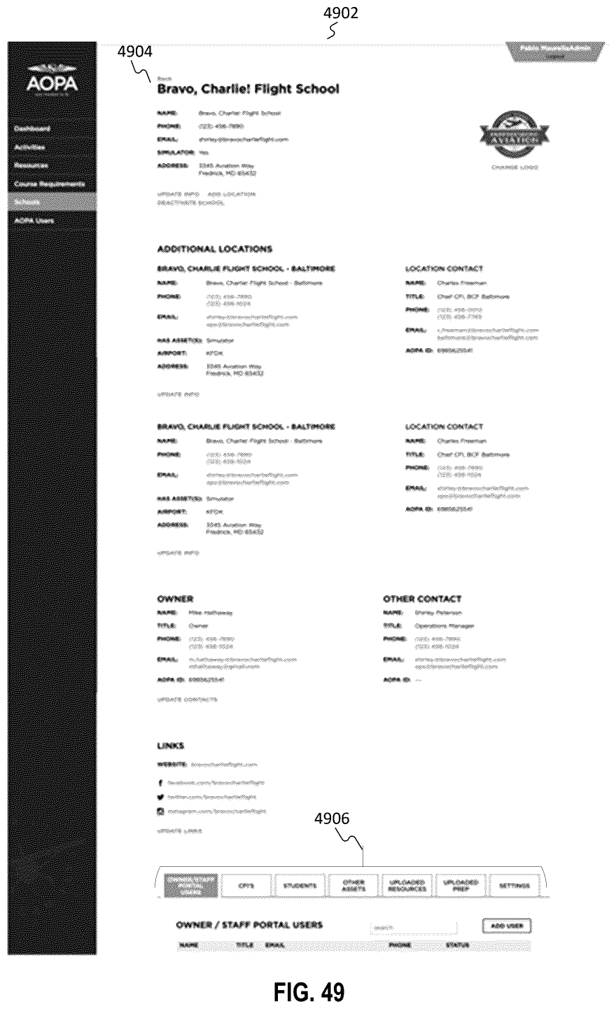

Furthermore, when a school is selected, the flight training tool administrator portal may display detailed school view 4902 as illustrated in FIG. 49. Detailed school view 4902 may include details 4904 such as a school logo, name, phone number, alternate phone number, email, alternate email, if a school has a flight simulator, owner name, owner title, owner phone number, owner alternate phone number, owner email, owner alternate email, owner AOPA ID number, and other school contact information. Detailed school view 4902 may also display tabs 4906 with owner/staff portal users, CFIs (including status and number of students), students (including name, goal, progress as a percentage, and status), aircraft (including type, designation, and year), and other assets (such as simulators).

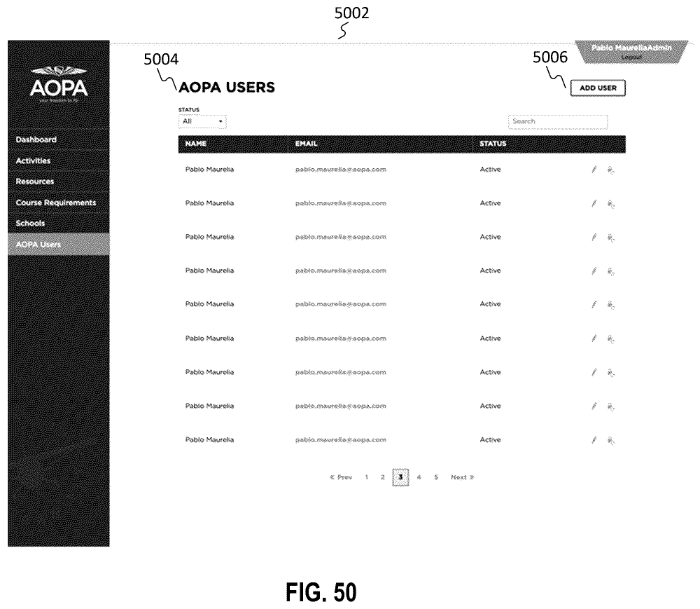

FIG. 50 is an illustration of an exemplary flight training tool administrator portal user list interface 5002, consistent with disclosed embodiments. User list interface 5002 may show a list of users 5004 in flight training networks and have sortable columns including name, email, and membership status. An add user button 5006 may also be included to allow an administrator to enter details for an additional user.

It is to be understood that references to AOPA in this application refer to an exemplary organization for purposes of explaining features of the disclosed system. The application description and claims are not intended to be limited to by the exemplary references to AOPA. Other organizations and information associated therewith may be used within the scope of this application. For example, references to AOPA ID, AOPA Personify API, and other AOPA resources are to be understood as describing exemplary embodiments for purposes of this description. Other types of user IDs, APIs, and other resources may be used and are contemplated by this description.

### CONCLUSION

While some features of flight training tools and flight training tool systems have been described with respect to the above embodiments, it should be understood that they are not limited thereto, and that various other features may be included or featured, depending on the information available or requested pertaining to flight training. For example, the components of and information displayed via user interfaces associated with flight planning tools consistent with this disclosure may be arranged differently (e.g., their components and information may be arranged in different locations with respect with each other) and/or may have different appearances (e.g., different visual design or aesthetic design). The accompanying figures are intended to provide exemplary views for purposes of explaining features and functions described herein, and they are not intended to limit the scope of those features or interfaces.

The exemplary disclosed embodiments describe a flight training tool. The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware, software, methods, and systems, but other systems and methods consistent with the present disclosure can be implemented.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. As used herein, unless specifically stated otherwise, being “associated with” may include being hosted by, being stored be, being accessible by, being connected with, being generated by, being influenced by, or being modifiable by. As used herein, unless specifically stated otherwise, being “based on” may include being dependent on, being interdependent with, being associated with, being defined at least in part by, being derived from, being influenced by, or being responsive to. As used herein, “related to” may include being inclusive of, being expressed by, being indicated by, or being based on. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Computer programs created on the basis of the written description and methods of this specification are within the skill of a software developer. The various programs or program modules can be created using a variety of programming techniques. For example, program sections or program modules can be designed in or by means of Java, Swift, C, C++, assembly language, or any such programming languages. One or more of such software sections or modules can be integrated into a computer system, computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

What is claimed is:

1. A system for flight training, comprising:
one or more non-transitory computer-readable memories storing instructions; and
one or more processors configured to execute the instructions to perform operations comprising:
initializing a state and a cognitive load parameter for respective pilot training tasks, wherein each state comprises at least one of review state, rollover state, skip state, or new state;
determining a subset of the pilot training tasks to include in a first data structure;
generating the first data structure including the subset of pilot training tasks;
receiving respective scores for the pilot training tasks from a device;
updating the respective states of the subset of pilot training tasks based on the received scores;
recalibrating the respective cognitive load parameters of the subset of pilot training tasks;
updating, based on the recalibrated respective cognitive loads, states of at least one of the subset of pilot training tasks and at least one pilot training task not in the subset; and
updating a second data structure based on the updated states.

2. The system of claim 1, wherein a sum of the cognitive load parameters of pilot training tasks in the subset does not exceed a threshold.

3. The system of claim 2, wherein determining the subset of the pilot training tasks comprises selecting a pilot training task from a first state, advancing to a subsequent state, and selecting a pilot training task from the subsequent state, until the sum reaches the threshold.

4. The system of claim 3, wherein:
a plurality of pilot training tasks is selected before advancing to a subsequent state; and
a number of a pilot training tasks selected from a state does not exceed a maximum number of a pilot training tasks permitted for the state.

5. The system of claim 3, wherein states from which a pilot training tasks in the subset are selected are iterated sequentially in an order of rollover, skip, review, and new.

6. The system of claim 3, wherein pilot training tasks related to operations at towered fields are selected ahead of a pilot training tasks related to operations at non-towered fields based on an indication of whether a designated training location is at a towered airport.

7. The system of claim 3, wherein:
a numerical rank reflecting a dependency chain of pilot training tasks is assigned to each pilot training task, with lower rank pilot training tasks being activities that must be completed before higher rank pilot training tasks; and
determining a pilot training task comprises determining a pilot training task activity having a lowest rank.

8. The system of claim 1, wherein:
the scores are initially recorded on a device when the device is not connected to a network; and
the operations further comprise synchronizing the scores stored on the device with scores stored in a database when the device is connected to a network.

9. The system of claim 1, wherein updating the cognitive load parameters comprises using the cognitive load parameters associated with the respective pilot training tasks and received scores associated with the respective pilot training task as inputs to determine respective updated cognitive load parameters.

10. The system of claim 1 wherein updating the state of a pilot training task comprises:
if the pilot training task is associated with a score not reaching a threshold, updating the state to a rollover state; and
if the pilot training task is associated with a score reaching the threshold, updating the state to a review state.

11. A computer-implemented method for flight training comprising:
executing, via at least one processor, instructions stored in a non-transitory computer-readable medium to perform operations comprising:
initializing a state and a cognitive load parameter for respective pilot training tasks, wherein each state comprises at least one of review state, rollover state, skip state, or new state;
determining a subset of the pilot training tasks to include in a first data structure;
generating the first data structure including the subset of pilot training tasks;
receiving respective scores for the pilot training tasks from a device;
updating the respective states of the subset of pilot training tasks based on the received scores;
recalibrating the respective cognitive load parameters of the subset of pilot training tasks;
updating, based on the recalibrated respective cognitive loads, states of at least one of the subset of pilot training tasks and at least one pilot training task not in the subset; and
updating a second data structure based on the updated states.

12. The computer-implemented method of claim 11, wherein a sum of the cognitive load parameters of pilot training tasks in the subset does not exceed a threshold.

13. The computer-implemented method of claim 12, wherein determining a the subset of the activities pilot training tasks comprises selecting an activity pilot training task from a first state, advancing to a subsequent state, and selecting a pilot training task an activity from the subsequent state, in an iterative manner until the sum reaches the threshold.

14. The computer-implemented method of claim 13, wherein:
a plurality of pilot training tasks is selected before advancing to a subsequent state; and
a number of a pilot training tasks selected from a state does not exceed a maximum number of a pilot training tasks permitted for the state.

15. The computer-implemented method of claim 13, wherein states from which a pilot training tasks in the subset are selected are iterated sequentially in an order of rollover, skip, review, and new.

16. The computer-implemented method of claim 13, wherein pilot training tasks related to operations at towered fields are selected ahead of a pilot training tasks related to operations at non-towered fields based on an indication of whether a designated training location is at a towered airport.

17. The computer-implemented method of claim 13, wherein:
a numerical rank reflecting a dependency chain of pilot training tasks is assigned to each pilot training task, with lower rank pilot training tasks being activities that must be completed before higher rank pilot training tasks; and
determining a pilot training task comprises determining a pilot training task activity having a lowest rank.

18. The computer-implemented method of claim 11, wherein:
the scores are initially recorded on a device when the device is not connected to a network; and
the operations further comprise synchronizing the scores stored on the device with the scores stored in the database when the device is connected to a network.

19. The computer-implemented method of claim 11, wherein updating the cognitive load parameters comprises using the cognitive load parameters associated with the respective pilot training tasks and received scores associated with the respective pilot training task as inputs to determine respective updated cognitive load parameters.

20. The computer-implemented method of claim 11, wherein updating the state of an activity comprises:
if the pilot training task is associated with a score not reaching a threshold, updating the state to a rollover state; and
if the pilot training task is associated with a score reaching the threshold, updating the state to a review state.
